(19) United States
(12) Patent Application Publication
(10) Pub. No.: US 2026/0148328 A1
(43) Pub. Date: May 28, 2026

(54) SPLITTING AND REJOINING EXECUTION OF PAIRED WAVES IN GRAPHICS PROCESSING

(71) Applicant: QUALCOMM Incorporated, San Diego, CA (US)

(72) Inventors: Yun DU, San Diego, CA (US); Zilin YING, San Diego, CA (US); Yang XIA, San Diego, CA (US); Wenfeng HUANG, San Diego, CA (US); Andrew Evan GRUBER, Arlington, MA (US); Chun YU, Rancho Santa Fe, CA (US); Eric DEMERS, San Diego, CA (US)

(21) Appl. No.: 18/962,849

(22) Filed: Nov. 27, 2024

(51) Int. Cl. G06T 1/20

(52) U.S. Cl. CPC G06T 1/20

(57) ABSTRACT

Aspects presented herein relate to methods and devices for graphics processing including an apparatus, e.g., a GPU. The apparatus may initiate an execution of a set of instructions including a first instruction and a second instruction. The apparatus may also determine whether data is pending for one of the first instruction or the second instruction Further, the apparatus may suspend the execution of the first instruction and the second instruction based on the data being pending for one of the first instruction or the second instruction.

### TECHNICAL FIELD

The present disclosure relates generally to processing systems and, more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor.

A graphics processor of a device may be configured to perform the processes in a graphics processing pipeline. Further, graphics processors may execute a number of different instructions in a graphics processing pipeline. However, there has developed a need for improved instruction execution in graphics processing.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a graphics processing unit (GPU), a central processing unit (CPU), or any apparatus that may perform for graphics processing. The apparatus may obtain an indication of a set of instructions including a first instruction and a second instruction, where the set of instructions is associated with graphics processing. The apparatus may also assign the first instruction and the second instruction to an execution unit in a set of execution units at a graphics processing unit (GPU). The apparatus may also initiate an execution of a set of instructions including a first instruction and a second instruction. Additionally, the apparatus may determine whether data is pending for one of the first instruction or the second instruction (e.g., the first instruction and the second instruction may be from different waves in a wave pair). The apparatus may also identify the first instruction and the second instruction as a low priority wave pair based on the data being pending for one of the first instruction or the second instruction (e.g., the first instruction and the second instruction may be from different waves in a wave pair). The apparatus may also set one or more bits in a context register based on identification of the first instruction and the second instruction as the low priority wave pair. Moreover, the apparatus may remove an assignment of the first instruction and the second instruction from the execution unit based on the identification of the first instruction and the second instruction as the low priority wave pair. The apparatus may also add the first instruction and the second instruction to a wave queue based on the removal of the assignment of the first instruction and the second instruction from the execution unit. The apparatus may also suspend the execution of the first instruction and the second instruction based on the data being pending for one of the first instruction or the second instruction (e.g., the first instruction and the second instruction may be from different waves in a wave pair). Also, the apparatus may monitor for whether the data remains pending for one of the first instruction or the second instruction (e.g., the first instruction and the second instruction may be from different waves in a wave pair). The apparatus may also determine that the data does not remain pending for one of the first instruction or the second instruction (e.g., the first instruction and the second instruction may be from different waves in a wave pair). The apparatus may also identify the first instruction and the second instruction as a normal priority wave pair based on the data not being pending for one of the first instruction or the second instruction (e.g., the first instruction and the second instruction may be from different waves in a wave pair). Further, the apparatus may complete the execution of the first instruction and the second instruction based on identification of the first instruction and the second instruction as the normal priority wave pair. The apparatus may also complete the execution of the first instruction and the second instruction based on the execution unit not being idle for one of the first instruction or the second instruction (e.g., the first instruction and the second instruction may be from different waves in a wave pair). The apparatus may also output an indication of suspension of the execution of the first instruction and the second instruction.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system in accordance with one or more techniques of this disclosure.

FIG. 2 illustrates an example graphics processing unit (GPU) in accordance with one or more techniques of this disclosure.

FIG. 3 is a diagram illustrating example processing components in accordance with one or more techniques of this disclosure.

FIG. 4 is a diagram illustrating an example GPU hardware in accordance with one or more techniques of this disclosure.

FIG. 5 is a diagram illustrating an example GPU in accordance with one or more techniques of this disclosure.

FIG. 6 is a diagram illustrating an example GPU in accordance with one or more techniques of this disclosure.

FIG. 7 includes diagrams illustrating an example GPU in accordance with one or more techniques of this disclosure.

FIG. 8 is a diagram illustrating an example instruction execution process in accordance with one or more techniques of this disclosure.

FIG. 9 is a diagram illustrating example shader code in accordance with one or more techniques of this disclosure.

FIG. 10 is a diagram illustrating an example instruction execution process in accordance with one or more techniques of this disclosure.

FIG. 11 is a communication flow diagram illustrating example communications between a GPU, a CPU/GPU, and a memory in accordance with one or more techniques of this disclosure.

FIG. 12 is a flowchart of an example method of graphics processing in accordance with one or more techniques of this disclosure.

FIG. 13 is a flowchart of an example method of graphics processing in accordance with one or more techniques of this disclosure.

### DETAILED DESCRIPTION

As indicated herein, there may be both positives and negatives to wave pairing or paired wave execution. For example, GPU resources may be utilized more efficiency, as two waves are being executed compared to a single wave. However, there is additional overhead at the GPU that is needed to synchronize the data for wave pairing. For instance, wave pairing may be viewed as a double wave, so the paired wave may take longer to track, which will in turn increase the overhead. So during paired wave execution, a GPU may wait longer for the cycles to take place versus an individual wave, which will have a negative impact on the GPU performance. Indeed, one issue of paired wave execution is that the GPU may be delayed when executing both of the wave pairs at once. Further, one of the execution slots and/or execution units may be waiting on one of the wave pairs. That is, paired wave execution may not allow a GPU to efficiently utilize execution slots and/or execution units. Based on the above, it may be beneficial to reduce the amount of overhead at a GPU that is needed for paired wave execution. Also, it may be beneficial to reduce the amount of time needed at a GPU to execute the paired wave. Further, it may be beneficial to more efficiently utilize execution slots and/or execution units during paired wave execution. Aspects of the present disclosure may help to reduce the overhead at a GPU that is needed during wave execution.

Aspects of the present disclosure may include a number of benefits or advantages. Aspects of the present disclosure may help to reduce the overhead at a GPU that is needed during wave execution. For instance, aspects presented herein may reduce the amount of overhead at a GPU that is needed for paired wave execution. Aspects presented herein may also reduce the amount of time needed at a GPU to execute waves. For example, aspects of the present disclosure may reduce the amount of time needed at a GPU to execute the paired wave. That is, aspects presented herein may allow a GPU to increase the speed and/or performance during paired wave execution. Also, aspects presented herein may increase the efficiency of resources utilization for wave execution. Indeed, aspects presented herein may more efficiently utilize execution slots and/or execution units during paired wave execution. By doing so, aspects presented herein may optimize the performance of a GPU during paired wave execution. Aspects herein may also eliminate the complexity to select a wave or wave pair to an execution slot, increase execution slot utilization, and/or improve instruction cache fetch utilization. Aspects herein may also reduce overhead for wave pair synchronization, as well as contribute to performance uplift at a GPU.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

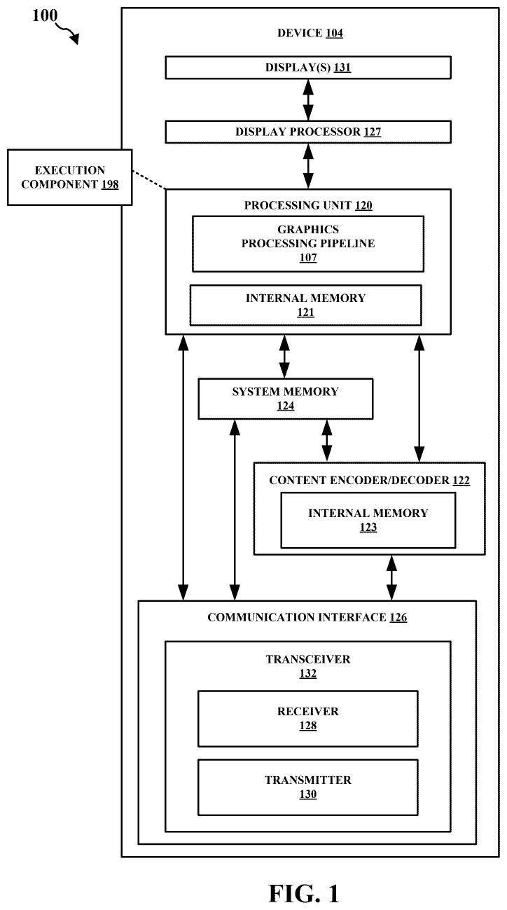

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include an execution component 198 configured to obtain an indication of a set of instructions including a first instruction and a second instruction, where the set of instructions is associated with graphics processing. The execution component 198 may also be configured to assign the first instruction and the second instruction to an execution unit in a set of execution units at a graphics processing unit (GPU). The execution component 198 may also be configured to initiate an execution of a set of instructions including a first instruction and a second instruction. The execution component 198 may also be configured to determine whether data is pending for one of the first instruction or the second instruction. The execution component 198 may also be configured to identify the first instruction and the second instruction as a low priority wave pair based on the data being pending for one of the first instruction or the second instruction. The execution component 198 may also be configured to set one or more bits in a context register based on identification of the first instruction and the second instruction as the low priority wave pair. The execution component 198 may also be configured to remove an assignment of the first instruction and the second instruction from the execution unit based on the identification of the first instruction and the second instruction as the low priority wave pair. The execution component 198 may also be configured to add the first instruction and the second instruction to a wave queue based on the removal of the assignment of the first instruction and the second instruction from the execution unit. The execution component 198 may also be configured to suspend the execution of the first instruction and the second instruction based on the data being pending for one of the first instruction or the second instruction. The execution component 198 may also be configured to monitor for whether the data remains pending for one of the first instruction or the second instruction. The execution component 198 may also be configured to determine that the data does not remain pending for one of the first instruction or the second instruction. The execution component 198 may also be configured to identify the first instruction and the second instruction as a normal priority wave pair based on the data not being pending for one of the first instruction or the second instruction. The execution component 198 may also be configured to complete the execution of the first instruction and the second instruction based on identification of the first instruction and the second instruction as the normal priority wave pair. The execution component 198 may also be configured to complete the execution of the first instruction and the second instruction based on the execution unit not being idle for one of the first instruction or the second instruction. The execution component 198 may also be configured to output an indication of suspension of the execution of the first instruction and the second instruction. Although the following description may be focused on graphics processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context will be processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU.

Context states may be utilized to determine how an individual processing unit functions, e.g., a vertex fetcher (VFD), a vertex shader (VS), a shader processor, or a geometry processor, and/or in what mode the processing unit functions. In order to do so, GPUs may use context registers and programming data. In some aspects, a GPU may generate a workload, e.g., a vertex or pixel workload, in the pipeline based on the context register definition of a mode or state. Certain processing units, e.g., a VFD, may use these states to determine certain functions, e.g., how a vertex is assembled. As these modes or states may change, GPUs may need to change the corresponding context. Additionally, the workload that corresponds to the mode or state may follow the changing mode or state.

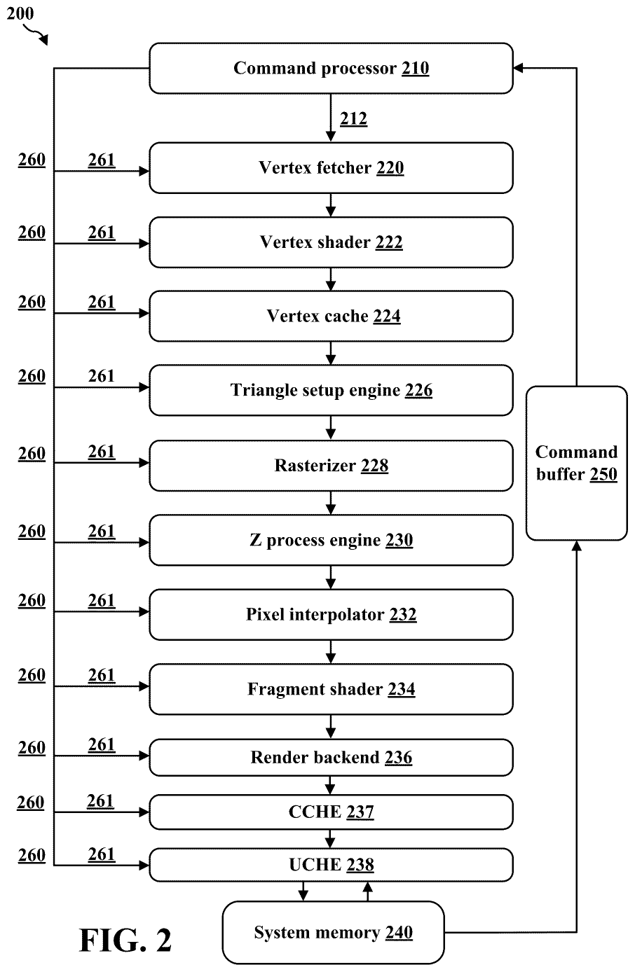

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 1 (L1) cache (cluster cache (CCHE)) 237, level 2 (L2) cache (UCHE) 238, and system memory 240. Although FIG. 2 displays that GPU 200 includes processing units 220-238, GPU 200 may include a number of additional processing units. Additionally, processing units 220-238 are merely an example and any combination or order of processing units may be used by GPUs according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1.

GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs may allow for both tiled rendering and direct rendering.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some types of GPUs may include different types of pipelines, such as a graphics processing pipeline. Graphics processing pipelines may include one or more of a vertex shader stage, a hull shader stage, a domain shader stage, a geometry shader stage, and a pixel shader stage. These stages of the graphics processing pipeline may be considered shader stages. These shader stages may be implemented as one or more shader programs that execute on shader units at a GPU. Shader units may be configured as a programmable pipeline of processing components. In some examples, a shader unit may be referred to as “shader processors” or “unified shaders,” and may perform geometry, vertex, pixel, or other shading operations to render graphics. Shader units may include shader processors, each of which may include one or more components for fetching and decoding operations, one or more arithmetic logic units (ALUs) for carrying out arithmetic calculations, one or more memories, caches, and registers.

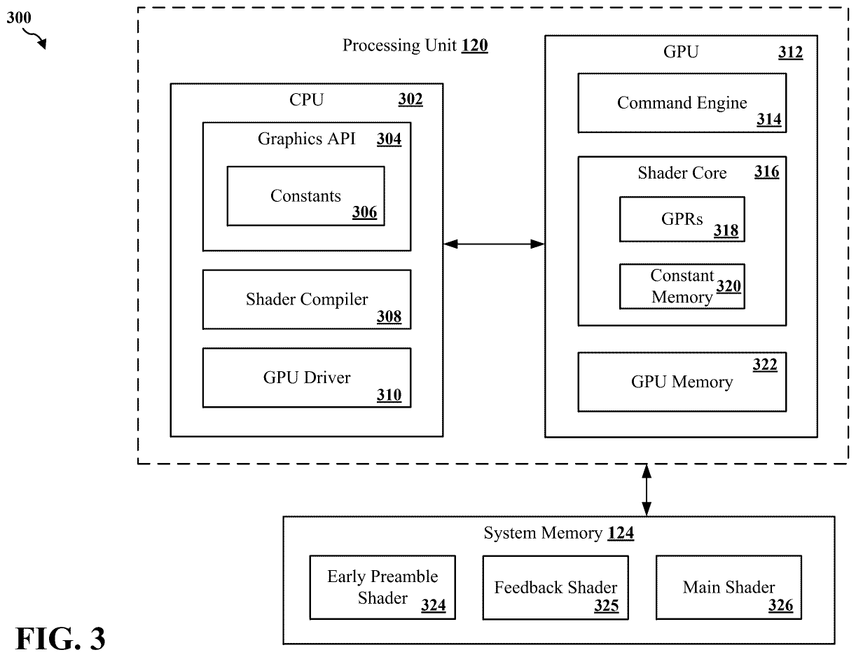

FIG. 3 is a diagram 300 that illustrates processing components, such as the processing unit 120 and the system memory 124, as may be identified in connection with the device 104 for processing data. In aspects, the processing unit 120 may include a CPU 302 and a GPU 312. The GPU 312 and the CPU 302 may be formed as an integrated circuit (e.g., a system-on-a-chip (SOC)) and/or the GPU 312 may be incorporated onto a motherboard with the CPU 302. Alternatively, the CPU 302 and the GPU 312 may be configured as distinct processing units that are communicatively coupled to each other. For example, the GPU 312 may be incorporated on a graphics card that is installed in a port of the motherboard that includes the CPU 302.

The CPU 302 may be configured to execute a software application that causes graphical content to be displayed (e.g., on the display(s) 131 of the device 104) based on one or more operations of the GPU 312. The software application may issue instructions to a graphics application program interface (API) 304, which may be a runtime program that translates instructions received from the software application into a format that is readable by a GPU driver 310. After receiving instructions from the software application via the graphics API 304, the GPU driver 310 may control an operation of the GPU 312 based on the instructions. For example, the GPU driver 310 may generate one or more command streams that are placed into the system memory 124, where the GPU 312 is instructed to execute the command streams (e.g., via one or more system calls). A command engine 314 included in the GPU 312 is configured to retrieve the one or more commands stored in the command streams. The command engine 314 may provide commands from the command stream for execution by the GPU 312. The command engine 314 may be hardware of the GPU 312, software/firmware executing on the GPU 312, or a combination thereof. While the GPU driver 310 is configured to implement the graphics API 304, the GPU driver 310 is not limited to being configured in accordance with any particular API. The system memory 124 may store the code for the GPU driver 310, which the CPU 302 may retrieve for execution. In examples, the GPU driver 310 may be configured to allow communication between the CPU 302 and the GPU 312, such as when the CPU 302 offloads graphics or non-graphics processing tasks to the GPU 312 via the GPU driver 310.

The system memory 124 may further store source code for one or more of an early preamble shader 324, a feedback shader 325, or a main shader 326. In such configurations, a shader compiler 308 executing on the CPU 302 may compile the source code of the shaders 324-326 to create object code or intermediate code executable by a shader core 316 of the GPU 312 during runtime (e.g., at the time when the shaders 324-326 are to be executed on the shader core 316). In some examples, the shader compiler 308 may pre-compile the shaders 324-326 and store the object code or intermediate code of the shader programs in the system memory 124. The shader compiler 308 (or in another example the GPU driver 310) executing on the CPU 302 may build a shader program with multiple components including the early preamble shader 324, the feedback shader 325, and the main shader 326. The main shader 326 may correspond to a portion or the entirety of the shader program that does not include the early preamble shader 324 or the feedback shader 325. The shader compiler 308 may receive instructions to compile the shader(s) 324-326 from a program executing on the CPU 302. The shader compiler 308 may also identify constant load instructions and common operations in the shader program for including the common operations within the early preamble shader 324 (rather than the main shader 326). The shader compiler 308 may identify such common instructions, for example, based on (presently undetermined) constants 306 to be included in the common instructions. The constants 306 may be defined within the graphics API 304 to be constant across an entire draw call. The shader compiler 308 may utilize instructions such as a preamble shader start to indicate a beginning of the early preamble shader 324 and a preamble shader end to indicate an end of the early preamble shader 324. Similar instructions may be used for the feedback shader 325 and the main shader 326. The feedback shader 325 will be described in further detail below.

The shader core 316 included in the GPU 312 may include general purpose registers (GPRs) 318 and constant memory 320. The GPRs 318 may correspond to a single GPR, a GPR file, and/or a GPR bank. Each GPR in the GPRs 318 may store data accessible to a single thread. The software and/or firmware executing on GPU 312 may be a shader program 324-326, which may execute on the shader core 316 of GPU 312. The shader core 316 may be configured to execute many instances of the same instructions of the same shader program in parallel. For example, the shader core 316 may execute the main shader 326 for each pixel that defines a given shape. The shader core 316 may transmit and receive data from applications executing on the CPU 302. In examples, constants 306 used for execution of the shaders 324-326 may be stored in a constant memory 320 (e.g., a read/write constant RAM) or the GPRs 318. The shader core 316 may load the constants 306 into the constant memory 320. In further examples, execution of the early preamble shader 324 or the feedback shader 325 may cause a constant value or a set of constant values to be stored in on-chip memory such as the constant memory 320 (e.g., constant RAM), the GPU memory 322, or the system memory 124. The constant memory 320 may include memory accessible by all aspects of the shader core 316 rather than just a particular portion reserved for a particular thread such as values held in the GPRs 318.

In some aspects, different types of GPU hardware may support different types of workload execution. For instance, GPU hardware may support concurrent execution of different workloads. Concurrent execution may refer to the simultaneous execution of workloads at a GPU. Also, concurrent execution may refer to the execution of workloads in parallel at a GPU. GPU hardware may also support concurrent execution of different workloads in a time-shared manner. In some instances, concurrent execution of different workloads in a time-shared manner may improve the performance per area at the GPU. However, in other instances, concurrent execution of different workloads in a time-shared manner may reduce the performance per area at the GPU. Additionally, different types of workloads may take a different amount of processing time in various stages of the GPU pipeline. Also, these types of workloads may introduce inefficiency in GPU hardware utilization.

In some aspects, scheduling algorithms in order to time-share the GPU hardware may sequence the workload to achieve the best utilization of GPU hardware. However, some types of workloads may block the execution of other successive workloads. For instance, some workloads with a higher specification for a resource (e.g., memory access latency) may block the execution of other successive workloads, which may have reduced resource specification and a faster execution time (e.g., head of line blocking). In turn, this may reduce the overall hardware efficiency at the GPU. This kind of workload pattern is common in certain types of binning (e.g., concurrent binning). For example, in concurrent binning, a tile sorting pass for a certain frame (e.g., frame ‘N+1’) may be run concurrently with a rendering pass of another frame (e.g., frame ‘N’).

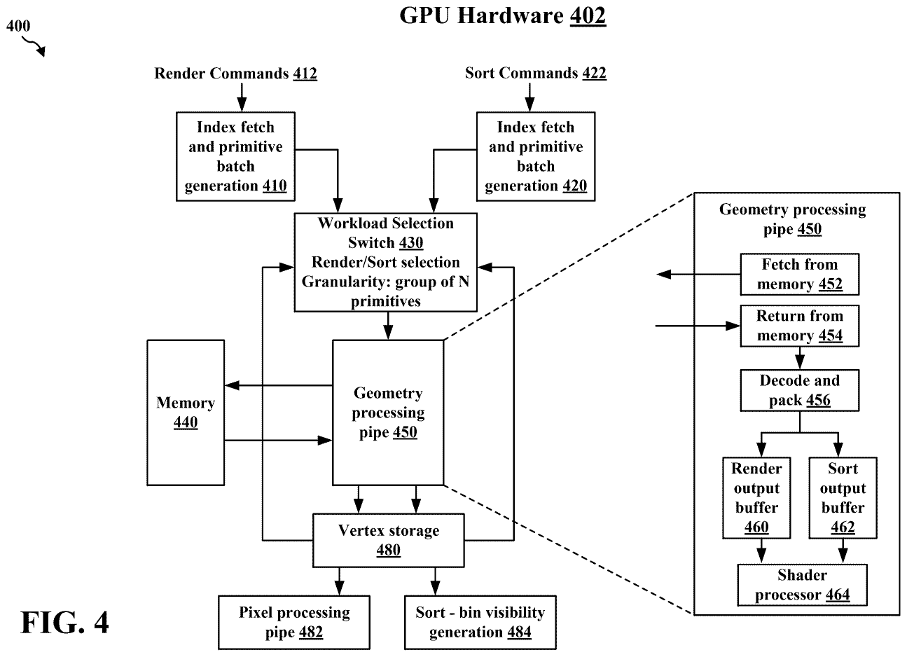

FIG. 4 illustrates diagram 400 including one example of GPU hardware. More specifically, diagram 400 depicts a time-shared GPU hardware for concurrent binning. As shown in FIG. 4, diagram 400 includes GPU hardware 402 including index fetch and primitive batch generation component 410, index fetch and primitive batch generation component 420, software 430, memory 440, geometry processing pipe 450, vertex storage component 480, pixel processing pipe 482, and sort-bin visibility generation component 484. As shown in FIG. 4, render commands 412 may be input to index fetch and primitive batch generation component 410, which may be output to software 430. Similarly, sort commands 422 may be input to index fetch and primitive batch generation component 420, which may be output to software 430. The software 430 may have a render/sort selection capability, as well as a certain granularity (e.g., a granularity for a group of N primitives). The output of software 430 may be sent to geometry processing pipe 450, which may communicate with memory 440. The geometry processing pipe 450 may include fetch from memory component 452, return from memory component 454, decode and pack component 456, render output buffer 460, sort output buffer 462, and shader processor 464. Also, the output of geometry processing pipe 450 may be sent to vertex storage component 480, which may be sent to pixel processing pipe 482 and sort-bin visibility generation component 484.

As shown in FIG. 4, geometry pipe hardware (e.g., geometry processing pipe 450) may be time shared between tile sorting and tile render workloads. Also, a scheduling algorithm (e.g., software 430) may consider the availability of GPU hardware for tile sorting and tile render workload. The granularity of a workload may be selected such that there is limited workload switching overhead. Further, the granularity of a workload may be selected such that, at the same time, one workload does not block the other. As shown in FIG. 4, the software 430 may have a granularity of a group of N primitives. For instance, for concurrent binning, the workload distribution granularity may be a primitive batch (e.g., a set of N primitives).

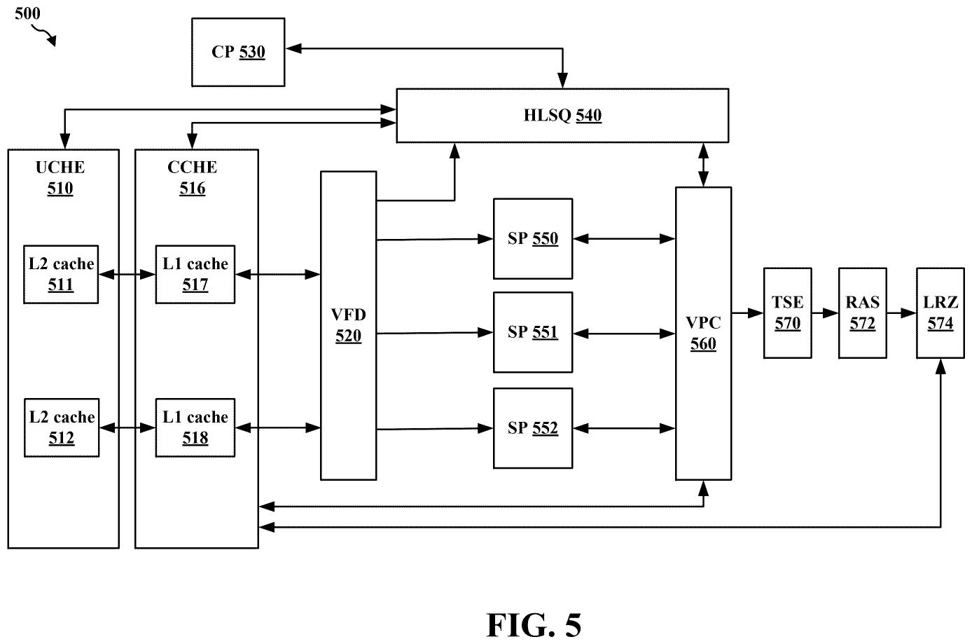

FIG. 5 is a diagram illustrating another example GPU. More specifically, FIG. 5 depicts GPU 500 including a number of different components. As shown in FIG. 5, GPU 500 includes UCHE 510 including L2 cache 511 and L2 cache 512, CCHE 516 including L1 cache 517 and L1 cache 518, VFD 520, CP 530, HLSQ 540, a number of shader processors (e.g., shader processor 550, shader processor 551, and shader processor 552), VPC 560, TSE 570, RAS 572, and low resolution Z (LRZ) component (e.g., LRZ 574). As shown in FIG. 5, CP 530 may transmit data to HLSQ 540 and receive data from HLSQ 540. CCHE 516 may transmit/receive data to/from HLSQ 540. UCHE 510 may also transmit/receive data to/from HLSQ 540. L2 cache 511 and L2 cache 512 may transmit/receive data to/from VFD 520. Further, VFD 520 may transmit data to HLSQ 540, as well as transmit data to shader processors 550-552. Moreover, shader processors 550-552 may transmit/receive data to/from VPC 560. Also, VPC 560 may transmit/receive data to/from HLSQ 540. Data can also be transmitted from VPC 560 to TSE 570, which can transmit data to RAS 572, and then to LRZ 574. CCHE 516 can transmit/receive data to/from VPC 560 and LRZ 574. Also, UCHE 510 can transmit/receive data to/from VPC 560 and LRZ 574.

As indicated herein, graphics processors (e.g., GPUs) may work in a number of different fashions (e.g., a single instruction, multiple data (SIMD) fashion). GPUs may process certain types of instructions that are associated with an operation (e.g., an SIMD operation). For instance, a GPU may process wave instructions or waves, which are the width of data elements that are operated on by a single instruction associated with the SIMD. The term wave may also refer to a set of threads or blocks that run concurrently on the GPU. Waves may be allocated into sub-waves, which may include a number of threads or fibers. An active thread/fiber may refer to a thread/fiber that executes instructions (e.g., instructions in the ALU). An inactive thread/fiber may refer to a thread/fiber that does not execute instructions. Threads/fibers that do not partake in a branching operation may eventually become inactive (i.e., partake in the next level of the hierarchy). A kernel may be a programming operations manager or a programming thread at a GPU. Also, a kernel may be executed in parallel by an array of threads/fibers, where all threads/fibers may run the same code. Each thread/fiber may have an identifier (ID) that it uses to compute memory addresses and make control decisions. GPUs may also process a number of different operations, such as an atomic operation. An atomic operation may enable another operation (e.g., a read-modify-write operation or a read-write operation) to occur without any interruption. As such, an atomic operation may assure that no other execution operation at a GPU may have been inserted between the target operation (e.g., a read-modify-write operation or a read-write operation).

In some aspects, a shader in the context of a graphics processor (e.g., a GPU) may be a program that is used to control the rendering effects of 3D computer graphics. There are different types of shaders (e.g., vertex shaders, pixel shaders, and geometry shaders), each of which may handle a different aspect of the rendering process. Shaders may be used to produce realistic lighting, shadows, textures, and other visual effects in video games, simulations, and other 3D applications. A shader processor may utilize one or more context states to perform various operations and calculations. For instance, a shader processor may be part of multiple shared cores for integer processing. Also, a shader processor may execute shader code (e.g., vertex shaders, fragment shaders, compute shaders, etc.). The shader processor may also be referred to as a shader core. Shader code may also be referred to as a shader and may refer to a user-defined program configured to run in a stage of the GPU. In an example, the shader code may be associated with the rendering of graphical content. The shader processor may include a number of different components, such as arithmetic logic units (ALUs) and general purpose registers (GPRs). An ALU may be a combinatorial digital circuit that performs arithmetic and bitwise operations on integer binary numbers (e.g., a signed integer, an unsigned integer, etc.). A GPR may be a register that stores both data and addresses, that is, the GPR may be a combined data/address register. A register may refer to a location that may be accessed by a processor. A register may include a small amount of relatively quickly accessible storage.

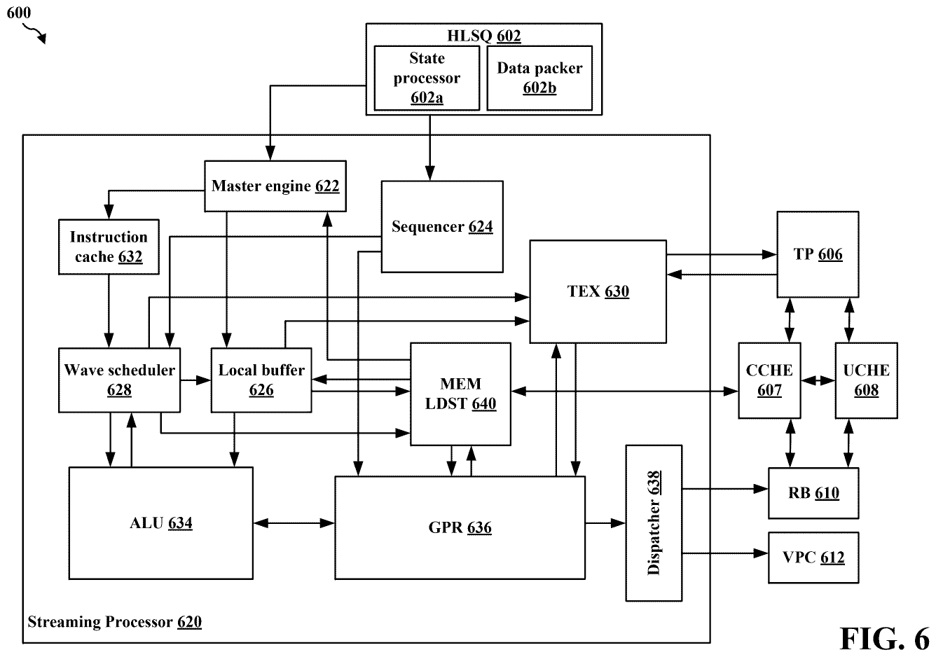

FIG. 6 illustrates an example GPU 600. Specifically, FIG. 6 illustrates a streaming processor or shader processor system in GPU 600. As shown in FIG. 6, GPU 600 includes a high level sequencer (HLSQ) 602, texture processor (TP) 606, level 1 (L1) cache (cluster cache (CCHE)) 607, level 2 (L2) cache (UCHE) 608, render backend (RB) 610, and vertex cache (VPC) 612. GPU 600 also includes streaming processor (SP) 620, master engine 622, sequencer 624, local buffer 626, wave scheduler 628, texture (TEX) 630, instruction cache 632, arithmetic logic unit (ALU) 634, GPR 636, dispatcher 638, and memory (MEM) load store (LDST) 640. In some aspects, streaming processor (SP) 620 may be referred to as a shader processor.

As shown in FIG. 6, each unit or block in GPU 600 may send data or information to other blocks. For instance, HLSQ 602 may send commands to the master engine 622. Also, HLSQ 602 may send vertex threads, vertex attributes, pixel threads, pixel attributes, and/or compute commands to the sequencer 624. TP 606 may receive texture requests from TEX 630, and send texture elements (texels) back to the TEX 630. Further, TP 606 may send memory read requests to and receive memory data from CCHE 607 or UCHE 608. CCHE 607 or UCHE 608 may also receive memory read or write requests from MEM LDST 640 and send memory data back to MEM LDST 640, as well as receive memory read or write requests from RB 610 and send memory data back to RB 610. Also, RB 610 may receive an output in the form of color from GPR 636, e.g., via dispatcher 638. VPC 612 may also receive output in the form of vertices from GPR 636, e.g., via dispatcher 638. GPR 636 may send address data or receive write back data from MEM LDST 640. GPR 636 may also send temporary data to and receive temporary data from ALU 634. Moreover, ALU 634 may send address or predicate information to the wave scheduler 628, as well as receive instructions from wave scheduler 628. Local buffer 626 may send constant data to ALU 634. TEX 630 may also receive texture attributes from or send texture data to GPR 636, as well as receive constant data from local buffer 626. Further, TEX 630 may receive texture requests from wave scheduler 628, as well as receive constant data from local buffer 626. MEM LDST 640 may send/receive constant data to/from local buffer 626. Sequencer 624 may send wave data to wave scheduler 628, as well as send data to GPR 636. The sequencer 624 may allocate resources and local memory. Also, the sequencer 624 may allocate wave slots and any associated GPR 636 space. For example, the sequencer 624 may allocate wave slots or GPR 636 space when the HLSQ 602 issues a pixel tile workload to the SP 620. Master engine 622 may send program data to instruction cache 632, as well as send constant data to local buffer 626 and receive instructions from MEM LDST 640. Instruction cache 632 may send instructions or decode information to wave scheduler 628. Wave scheduler 628 may send read requests to local buffer 626, as well as send memory requests to MEM LDST 640.

As further shown in FIG. 6, the HLSQ 602 may prepare one or more context states for the SP 620. For example, the HLSQ 602 may prepare the context states for different types of data, e.g., global register data, shader constant data, buffer descriptors, instructions, etc. Additionally, the HLSQ 602 may embed context states into a command stream to the SP 620. The master engine 622 may parse the command stream from the HLSQ 602 and setup an SP global state. Moreover, the master engine 622 may fill or add to an instruction cache 632 and/or a local buffer 626 or a constant buffer. In some aspects, inside the HLSQ 602, there may be an internal function unit called a state processor 602a. The state processor 602a may be a single fiber scalar processor that may execute a special shader program, e.g., a preamble shader. The preamble shader may be generated by the GPU compiler in order to load constant data from different buffer objects. Also, the preamble shader may bind the buffer objects into a single constant buffer, such as a post-process constant buffer. Further, the HLSQ 602 may execute the preamble shader and, as a result, skip utilizing a main shader. In some instances, the main shader may perform different shading tasks, such as normal vertex shading and/or a fragment shading program. Moreover, the HLSQ 602 may include a data packer 602b.

Additionally, as shown in FIG. 6, the SP 620 may not be limited to executing a preamble if the HLSQ 602 decides to skip a preamble execution. For instance, the SP 620 may also process a conventional graphics workload, such as vertex shading and/or fragment shading. In some aspects, the SP 620 may utilize its execution units and storage in order to process compute tasks as a general purpose GPU (GPGPU). Inside the SP 620, there may be multiple parallel instruction execution units such as an ALU, elementary function unit (EFU), branching unit, TEX, general memory read and write (aka LDST), etc. The SP 620 may also include on-chip storage memory, such as a GPR 636 which may store per-fiber private data. Also, the SP 620 may include a local buffer 626 which stores per-shader or per-kernel constant data, per-wave uniform data (aka uGPR), and per-compute work group (WG) local memory (LM). Processing a preamble shader may take up one wave slot. Further, the majority of preamble shaders may use just the uGPR and not the GPR, and may execute ALU instructions on a scalar ALU. Therefore, execution of the preamble shader may be associated with high performance, and may be power efficient because any available wave slot may be used to execute the preamble shader even without GPR space allocation.

Moreover, as shown in FIG. 6, dispatcher 638 may fetch data from GPR 636. Dispatcher 638 may also perform format conversion, and then dispatch a final color to multiple render targets (RTs). Each RT may have one or more components, such as red (r) green (G) blue (B) alpha (A) (RGBA) data, or just an alpha component of the RGBA data. Further, each RT may be generally stored in a vector GPR, i.e., R3.0 may store red data, R3.1 may store green data, R3.2 may store blue data, etc. Also, a driver program in an SP context register may be utilized to define the GPR identifier (ID) which stores RT data.

As indicated herein, a kernel may be a programming operations manager or a programming thread at a GPU. Also, a kernel may be executed in parallel by an array of threads, where all threads may run the same code. Each thread may have an identifier (ID) that it uses to compute memory addresses and make control decisions. A warp may be a collection of threads (e.g., 32 threads) that are executed simultaneously by a symmetric multiprocessor (SM). A warp may be a basic unit of execution, where multiple warps may be executed on an SM at once. When a program on a CPU invokes a kernel grid, the blocks of the grid may be enumerated and distributed to SMs with available execution capacity. The threads of a thread block may execute concurrently on one SM, and multiple thread blocks may execute concurrently on one SM. As thread blocks terminate, new blocks are launched on the vacated SMs. The mapping between warps and thread blocks may affect the performance of the kernel. Also, a clock or GPU clock may be a logical beat or time that is used to synchronize actions of the GPU. A clock source may manage how a GPU component derives its clock.

A symmetric multiprocessor (SM) may be single instruction multiple thread processor which has multiple shared cores at a GPU (e.g., shader processors) for integer processing, special functional units (SFUs) (e.g., for calculating functions such as sine, cosine, root mean-squared (RMS), etc.). The SM may have load store (LD/ST) units for load and store into memory/registers. The SM may also have L1 caches, shared caches and large-banked register files. A concurrent thread array (CTA) may be a basic workload unit assigned to an SM in a GPU. Threads in a CTA may be sub-grouped into a warp/wavefronts, which is the smallest execution unit sharing the same program counter. A last level cache (LLC) may be a last level of cache from a GPUs context, such as an extended cache for SMs. An interconnect unit may be a crossbar switch which does multi-master arbitration, by which GPUs are connected to rest of the world. Further, a pointer of serialization/pointer of coherence (PoS/PoC) may be point in the system-on-chip (SoC) post where every master in the system may see the same coherent copy of data.

Some aspects of graphics processing may utilize certain GPU architectures and/or application structures. For instance, aspects of graphics processing may utilize a general purpose GPU (GPGPU) architecture that includes symmetric multiprocessor (SMs), shared cores, an interconnect unit, a dynamic random access memory (DRAM), and/or a number of different caches (e.g., a first level (L1) cache, a second level (L2) cache, and/or a last level cache (LLC)). In some instances of GPU architectures, a number of SMs, shared cores, and L1 caches may be connected to an interconnect unit. The interconnect unit may be connected to L2 caches and DRAMs. Additionally, in an application structure, an application may include a number of kernels, and each of the kernels may include concurrent thread arrays (CTAs), where each CTA includes a number of warps.

In aspects of graphics rendering, some graphics applications may render to a single target, i.e., a render target, one or more times. For instance, in graphics rendering, a frame buffer on a system memory may be updated multiple times. The frame buffer may be a portion of memory or random access memory (RAM) (e.g., containing a bitmap or storage) to help store display data for a GPU. The frame buffer may also be a memory buffer containing a complete frame of data. Additionally, the frame buffer may be a logic buffer. In some aspects, updating the frame buffer may be performed in bin or tile rendering, where, as discussed above, a surface is divided into multiple bins or tiles and then each bin or tile may be separately rendered. Further, in tiled rendering, the frame buffer may be partitioned into multiple bins or tiles.

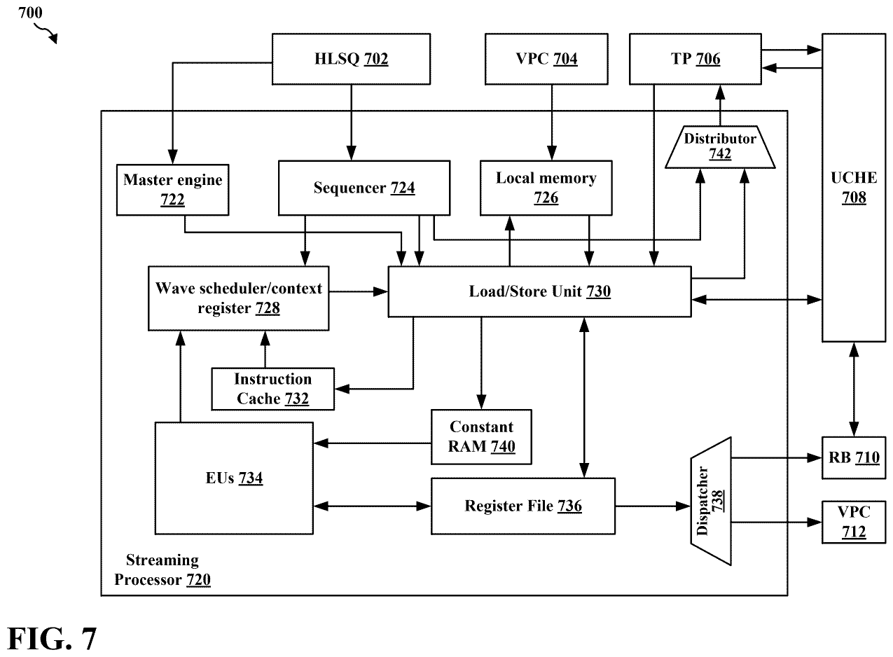

FIG. 7 illustrates an example GPU 700. More specifically, FIG. 7 illustrates a streaming processor (SP) system in GPU 700. As shown in FIG. 7, GPU 700 includes high level sequencer (HLSQ) 702, VPC 704, texture processor (TP) 706, UCHE 708 (e.g., an L2 configurable cache), RB 710, VPC 712, and SP 720. SP 720 includes master engine 722, sequencer 724, local memory 726, wave scheduler/context register 728, load/store unit 730 (e.g., texture (TEX) or load controller), instruction cache 732, execution units (EUs) 734, register file 736 (e.g., a general purpose register (GPR)), dispatcher 738 (e.g., texture distributor), constant RAM 740, and output distributor 742. The wave scheduler/context register 728 may include one or more wave slots. In some aspects, streaming processor (SP) 720 may be referred to as a shader processor.

As shown in FIG. 7, the SP 720 may include traditional function units or blocks (e.g., EUs 734 or sequencer 724). EUs 734 may execute or process some of the desired functions of the GPU. The sequencer 724 may allocate resources and local memory. Also, the sequencer 724 may allocate wave slots and any associated register file 736 space. For example, the sequencer 724 may allocate wave slots or register file 736 space when the HLSQ 702 issues a pixel tile workload to the SP 720. In some aspects, the wave scheduler/context register 728 may execute a pixel shader or issue instructions to the EUs 734. The EUs 734 may also include an arithmetic logic unit (ALU) and/or an elementary function unit (EFU). Further, the load/store unit 730 may be considered an execution unit. Moreover, the load/store unit 730 may correspond to one or multiple units. For instance, the load/store unit 730 may perform a texture fetch and/or the load/store unit 730 may perform a memory fetch. In some aspects, the instruction cache 732 may store a program to be executed. Also, the constant RAM 740 may store the constant that may be needed for a constant or uniform formation. As further shown in FIG. 7, the SP 720 may interface with the outside blocks, e.g., HLSQ 702, VPC 704, TP 706, UCHE 708, RB 710, and VPC 712. These blocks 702-712 may utilize user provided input and/or the SP may output results to these blocks or memory access.

As shown in FIG. 7, each unit or block in GPU 700 may send data or information to other blocks. For instance, HLSQ 702 may send programming/commands to the master engine 722. Also, HLSQ 702 may send vertex threads, vertex attributes, pixel threads, and/or pixel attributes to the sequencer 724. Master engine 722 may send an instruction, constant request to load/store unit 730. VPC 704 may send certain coefficients to local memory 726. TP 706 may send texture data to the load/store unit 730. TP 706 may also receive texture requests from load/store unit 730, e.g., via output distributor 742, and bypass requests from sequencer 724. Further, TP 706 may send requests to and receive texture elements (texels) from UCHE 708. UCHE 708 may also send memory data to and receive memory requests from load/store unit 730, as well as send memory data to and receive memory requests from RB 710. Also, RB 710 may receive an output in the form of color from register file, e.g., via dispatcher 738. VPC 712 may also receive output in the form of vertices from register file 736, e.g., via dispatcher 738. Register file 736 may also send temporary data to and receive temporary data from EUs 734. Moreover, EUs 734 may send address or predicate information to the wave scheduler/context register 728, as well as receive constant data from constant RAM 740. Load/store unit 730 may also send/receive load or store data to/from register file 736, as well as send store data to, and receive load data from, local memory 726. Further, load/store unit 730 may send global data to constant RAM 740 and update information to the instruction cache 732. Load/store unit 730 may also receive attribute data from sequencer 724 and synchronization information from wave scheduler/context register 728. Additionally, wave scheduler/context register 728 may receive decode information from instruction cache 732 and thread data from sequencer 724.

As mentioned above, the GPU 700 may process workloads (e.g., a pixel or vertex workload). In some aspects, these workloads may correspond to, or be referred to as, waves or wave formations. For instance, each workload or operation may use a group of vertices or pixels as a wave. For example, each wave may include 64 vertices or 64 pixels. In some instances, GPU 700 may send a wave formation, e.g., a pixel or vertex workload, to the wave scheduler/context register 728 for execution. For a vertex workload, the GPU may perform a vertex transformation. For a pixel workload, the GPU may perform a pixel shading or lighting.

In some aspects, each of the aforementioned processes or workloads (e.g., the processes or workloads in the SP 720) may include a wave formation. For example, a vertex workload may include a number of vertices, e.g., three vertices. SP 720 may then perform a transformation of these vertices, such that the vertices may transform into a wave. In order to perform this transformation, GPUs may utilize a number of a wave slots (e.g., to help transform the vertices into a wave). Further, in order to execute a workload or program, the GPU may also allocate the GPR space, e.g., including a temporary register to store any temporary data. Additionally, the sequencer 724 may allocate the register file 736 space and one or more wave slots in order to execute a wave. For example, the register file 736 space and one or more wave slots may be allocated when a pixel or vertex workload is issued. In some aspects, the wave scheduler/context register 728 may process a pixel workload and/or issue instructions to various execution units (e.g., EUs 734). The wave scheduler/context register 728 may also help to ensure data dependency between instructions, e.g., data dependency between ALU operands due to the pipeline latency and/or texture sample return data dependency based on a synchronization mechanism.

As shown in FIG. 7 above, GPUs may utilize a streaming processor (SP) 720 (e.g., a sequencer 724 in SP 720) to allocate different workloads to different wave slots. For instance, sequencer 724 may allocate wave slots and associated general purpose register (GPR) space for workloads (e.g., a high level sequencer (HLSQ) issue pixel tile workload (i/j barycentric coefficient data)) to SP 720. Next, a wave scheduler/context register 728 may execute a pixel shader and issue instructions to execution units (EUs) 734 (e.g., arithmetic logic unit (ALU), elementary function unit (EFU), texture (TEX) or load controller (LOAD)). After the shader processing is complete, the SP 720 may dispatch the processed result (i.e., mostly color) to a downstream block (e.g., a render backend (RB) 710). In some aspects, the output order of this process may be the same as the input order, which may be a functional specification. The SP 720 may work efficiently because wave slots that accept and execute a workload earlier may generally finish processing the workload earlier.

In some aspects, as shown in FIG. 7, high level sequencer (HLSQ) 702 may dispatch context states such as global register, shader constant, buffer descriptor, instruction, etc. The HLSQ 702 may also embed context states into a command stream to the master engine 722 (e.g., an SP master engine). In turn, the master engine 722 (e.g., an SP master engine) may parse the command stream from HLSQ 702 and set up an SP global state. The sequencer 724 (aka SEQ) may then allocate wave slots and associated GPR space when the HLSQ 702 dispatches workloads (e.g., vertex or pixel tile workloads) to the SP. Then the wave scheduler/context register 728 may execute vertex or pixel shader workloads and issue instructions to execution units (EUs) 734, such as ALU, EFU, TEX/LOAD, etc. After the shader processing is complete, the SP 720 may dispatch the result to a downstream block (e.g., render backend (RB) 710).

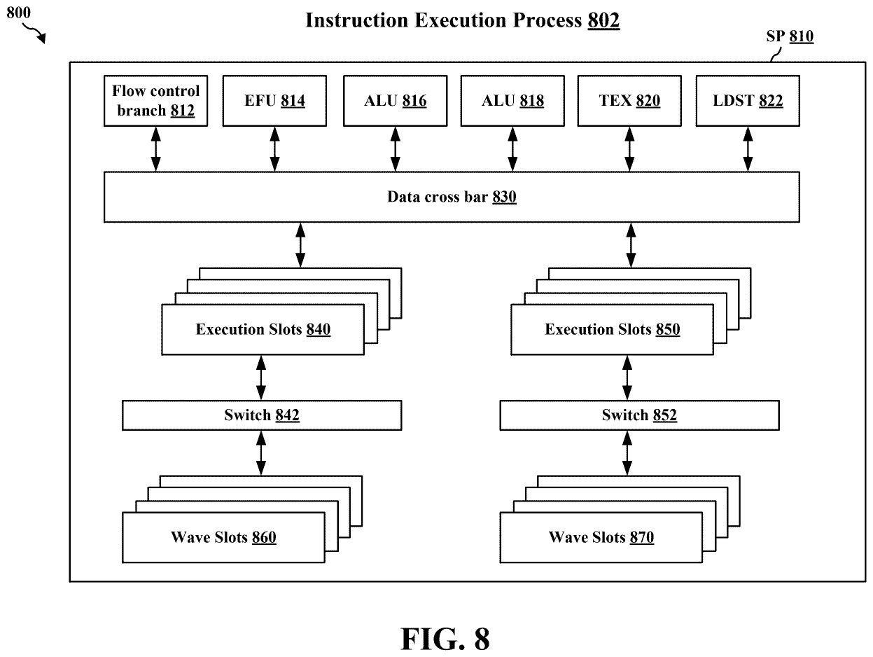

FIG. 8 illustrates diagram 800 including an example instruction execution process. More specifically, diagram 800 depicts one example of an instruction execution process 802 within SP 810 at a GPU. As shown in FIG. 8, diagram 800 includes a number of execution units (e.g., flow control branch 812, EFU 814, ALU 816, ALU 818, TEX 820, and load store (LDST) 822). SP 810 may include a number of additional execution units, as execution units 812-822 are merely an example and any combination or order of execution units can be used by GPUs herein. SP 810 may also include data cross bar 830, which can also be referred to as multiple thread manager and/or a level zero (L0) cache. SP 810 also includes execution slots 840, switch 842 (e.g., a 16-to-4 switch), execution slots 850, and switch 852 (e.g., a 16-to-4 switch). Further, SP 810 includes a number of wave slots (e.g., wave slots 860 and wave slots 870). SP 810 may include any number of different wave slots, as wave slots 860 and wave slots 870 are merely an example. In some aspects, wave slots 860 and wave slots 870 may be part of a wave scheduler.

As shown in FIG. 8, each component in SP 810 may communicate with a number of other components. For instance, each of the execution units (e.g., flow control branch 812, EFU 814, ALU 816, ALU 818, TEX 820, and LDST 822) may send or receive data or instructions (e.g., requests or grants) to/from the data cross bar 830. Also, each of the wave slots 860 and wave slots 870 can send or receive data or instructions (e.g., requests or grants) to/from the data cross bar 830. Further, data cross bar 830 may store data in, or receive data from, an L0 cache. Each of the execution units (e.g., flow control branch 812, EFU 814, ALU 816, ALU 818, TEX 820, and LDST 822) may also send or receive data or instructions to/from the wave slots 860 and wave slots 870. In some aspects, each of the wave slots 860 and wave slots 870 may issue instructions simultaneously to each of the execution units (e.g., flow control branch 812, EFU 814, ALU 816, ALU 818, TEX 820, and LDST 822).

FIG. 8 illustrates that SP 810 includes wave slots 860 and wave slots 870. In some aspects, the wave slots 860 and wave slots 870 may be referred to as flat wave slots, as each of the wave slots 860 and wave slots 870 may execute wave instructions on an individual basis without regard for the other wave slots. When an individual wave instruction is processing through the system, the corresponding wave slot may wait for the wave instruction to return (i.e., the wave slot can be in standby mode). Additionally, the context registers used in the wave slot logic may control wave execution and be flop-based, such as to enable switching between wave slots in order to access different EUs. As such, these context registers may need to be updated.

In some aspects, as shown in FIG. 8, a higher number of the number of wave slots can utilize a cross bar with an increased scaling ability between the wave slots and the execution units. For example, in SP 810, data cross bar 830 may need an increased scaling ability to increase the number of wave slots 860 and wave slots 870, which may result in a larger data cross bar 830. For example, SP 810 includes wave slots 860 and wave slots 870 and execution units (e.g., flow control branch 812, EFU 814, ALU 816, ALU 818, TEX 820, and LDST 822), so the data cross bar 830 may help to convert and manage this wave slot to execution unit ratio. So the data cross bar 830 can scale the number of wave instructions for every execution unit. Accordingly, if the number of wave slots is increased, then the data cross bar 830 may need to be adjusted to convert a different amount of wave slot instructions to the execution units.

FIG. 8 illustrates an example of a wave scheduler, which includes wave slots (aka Hwave slots) and execution slots (aka Eslots), as well as a wave slot queue, and execution slot queue hierarchy, an instruction scheduling arbiter, and execution units (e.g., a decoder). Wave slot context registers may store information, such as instruction program counter (PC), fiber coverage mask, shader type, etc., which is associated with input data. Once a wave slot is ready to execute an instruction, a wave scheduler may copy the wave slot context registers to an execution slot. After this, the wave scheduler may start to dispatch instructions to corresponding execution units, track an instruction execution, synchronize data dependency, switch out stalled waves (i.e., waves that are waiting for data to return from external memory) from an execution slot to a wave slot queue. The wave scheduler may also switch in ready wave slots to an execution slot.

As shown in FIG. 8, an execution unit (e.g., flow control branch 812, EFU 814, ALU 816, ALU 818, TEX 820, and LDST 822) may be a standalone programmable unit that performs calculations and operations based on instructions from an instruction unit. Execution units (e.g., flow control branch 812, EFU 814, ALU 816, ALU 818, TEX 820, and LDST 822) may be tailored to support specific datatypes, such as floating-point or integers. Some types of execution units (e.g., flow control branch 812, EFU 814, ALU 816, ALU 818, TEX 820, and LDST 822) may have multiple parallel functional units. An execution slot (e.g., execution slots 840 or execution slots 850) may be a set of resources that include one or more execution units (e.g., flow control branch 812, EFU 814, ALU 816, ALU 818, TEX 820, and LDST 822). Also, an execution slot (e.g., execution slots 840 or execution slots 850) may include a data path and operation issue machinery that surrounds the execution slot. In some aspects, a compute model at a GPU may include a host and one or more compute devices, each of which contains multiple execution units (e.g., flow control branch 812, EFU 814, ALU 816, ALU 818, TEX 820, and LDST 822).

In some aspects, an execution slot may execute one wave or multiple waves. The multiple waves may be executed as a wave pair or a tied wave pair. Paired wave execution may have a number of advantages, such as reducing an instruction cache (I$) fetch in half (compared to executing a single wave). Also, paired wave execution may enable an increase (e.g., a 2× increase) in an ALU execution rate (e.g., a 16-bit ALU execution rate) when the ALU structure (e.g., a single-instruction, multiple-data (SIMD) ALU structure) supports certain operations (e.g., 2×16-bit operations compared to 32-bit operations). Further, paired wave execution may allow a GPU to save power to execute one instruction with multiple waves worth of data. However, a significant issue with paired wave execution is the amount of overhead needed to synchronize a certain amount of data (e.g., 2× worth of data). This may occur because an SP scheduler may use an external/internal data load reference counter (e.g., a load reference counter (lrc)/short lrc (slrc)) in order to track a return of non-fixed latency external/internal data. As such, waiting for paired wave data return (e.g., lrc/slrc=0) may take a longer time period (e.g., twice the number of cycles compared to one individual wave). This overhead also applies to other data (e.g., EFU data (internal data) and/or texture and memory load data (external data)). As such, paired wave execution may have a negative impact on the performance of a GPU. Due to the pros and cons of wave pairing, an SP scheduler may attempt to schedule an execution slot with a wave pair, as well as schedule an execution slot with an individual wave dynamically.

As indicated herein, there may be both positives and negatives to wave pairing or paired wave execution. For example, GPU resources may be utilized more efficiency, as two waves are being executed compared to a single wave. However, there is additional overhead at the GPU that is needed to synchronize the data for wave pairing. For instance, wave pairing may be viewed as a double wave, so the paired wave may take longer to track, which will in turn increase the overhead. So during paired wave execution, a GPU may wait longer for the cycles to take place versus an individual wave, which will have a negative impact on the GPU performance. Indeed, one issue of paired wave execution is that the GPU may be delayed when executing both of the wave pairs at once. Further, one of the execution slots and/or execution units may be waiting on one of the wave pairs. That is, paired wave execution may not allow a GPU to efficiently utilize execution slots and/or execution units. Based on the above, it may be beneficial to reduce the amount of overhead at a GPU that is needed for paired wave execution. Also, it may be beneficial to reduce the amount of time needed at a GPU to execute the paired wave. Further, it may be beneficial to more efficiently utilize execution slots and/or execution units during paired wave execution.

Aspects of the present disclosure may help to reduce the overhead at a GPU that is needed during wave execution. For instance, aspects presented herein may reduce the amount of overhead at a GPU that is needed for paired wave execution. Aspects presented herein may also reduce the amount of time needed at a GPU to execute waves. For example, aspects of the present disclosure may reduce the amount of time needed at a GPU to execute the paired wave. That is, aspects presented herein may allow a GPU to increase the speed and/or performance during paired wave execution. Also, aspects presented herein may increase the efficiency of resources utilization for wave execution. Indeed, aspects presented herein may more efficiently utilize execution slots and/or execution units during paired wave execution. By doing so, aspects presented herein may optimize the performance of a GPU during paired wave execution.

Aspects of the present disclosure may execute some instructions (e.g., wave instructions) in a wave pair at a certain execution unit and/or execution slot. Also, aspects presented herein may execute other instructions (e.g., wave instructions) in the wave pair at another execution unit and/or execution slot. In some instances, aspects presented herein may prioritize different waves in a wave pair. For instance, aspects presented herein may assign one priority to one wave within a wave pair, and assign another priority to another wave within the wave pair. For example, one wave in a wave pair may be assigned a first priority in a wave priority hierarchy (e.g., a low wave priority) and another wave in a wave pair may be assigned a second priority in the wave priority hierarchy (e.g., a normal wave priority). Also, one wave in a wave pair may be assigned a second priority in a wave priority hierarchy (e.g., a normal wave priority) and another wave in a wave pair may be assigned a third priority in the wave priority hierarchy (e.g., a high wave priority). That is, one wave in a wave pair may be assigned a higher priority in a wave priority hierarchy and another wave in a wave pair may be assigned a lower priority in a wave priority hierarchy. So aspects presented herein may prioritize different waves within a wave pair. By doing so, aspects presented herein may more efficiently utilize execution slots and/or execution units during paired wave execution. Indeed, aspects presented herein may optimize the performance of a GPU during paired wave execution.

In some instances, aspects presented herein (e.g., an SP or SP scheduler at a GPU) may assign a first wave (including a first instruction) in a wave pair to an execution unit in a set of execution units. An SP or SP scheduler may assign a second wave (including a second instruction) in the wave pair to an execution unit in a set of execution units. The execution unit for the first wave may be the same as, or different from, the execution unit for the second wave. The SP or SP scheduler may then initiate the execution of the first wave (including the first instruction) and the second wave (including the second instruction). Next, the SP or SP scheduler may determine whether data is pending for one of the first wave or the second wave. If data is pending for one of the first wave or the second wave, the SP or SP scheduler may identify the first wave and the second wave as a low priority wave pair. The low priority wave pair may include a lower priority compared to a normal priority wave pair in a wave pair hierarchy. Also, the low priority wave pair for the first wave and the second wave may correspond to a partially ready wave pair. That is, if data is pending for the first wave or the second wave, then the first wave and the second wave may be classified as a low priority wave pair or a partially ready wave pair, which may be a low priority wave pair within a wave pair hierarchy.

Additionally, the SP or SP scheduler may set one or more bits in a context register if the first wave and the second wave are classified as a low priority wave pair. That is, the SP or SP scheduler may set one or more bits in a context register if data is pending for the first wave or the second wave. Also, the SP or SP scheduler may add the first wave and the second wave to a wave queue if the first wave and the second wave are classified as a low priority wave pair. Once added to the wave queue, the first wave and the second wave may be executed at a later time or after higher priority waves.

In some aspects, the SP or SP scheduler may suspend (i.e., pause or stop) the execution of the first wave and the second wave if the first wave and the second wave are classified as a low priority wave pair. That is, the SP or SP scheduler may suspend (i.e., pause or stop) the execution of the first wave and the second wave if (data is pending for the first wave or the second wave. This suspension of the execution of the first wave and the second wave may be based on a synchronization point or a branching instruction. Further, one wave in a wave pair may be suspended while the other wave in the wave pair may be started. For instance, the execution of the first wave may be suspended, but the execution of the second wave may be started if the second wave is ready for execution.

In some instances, once the execution of the first wave and/or the second wave has been suspended, the SP or SP scheduler may monitor for whether data is still pending for one of the first instruction or the second instruction (e.g., the first instruction and the second instruction may be from different waves in a wave pair). The SP or SP scheduler may determine that data is not pending for the first wave or the second wave. Also, the SP or SP scheduler may identify the first wave and the second wave as a normal priority wave pair based on the data not being pending for the first wave or the second wave. That is, the SP or SP scheduler may increase a wave priority in a wave pair hierarchy for the first wave or the second wave. The SP or SP scheduler may also complete the execution of the first wave or the second wave based on the wave pair being a normal priority wave pair. This execution of the first wave and the second wave may be completed in a paired wave mode. Moreover, the SP or SP scheduler may complete the execution of the first wave and the second wave based on the execution unit not being idle for the first wave and the second wave.

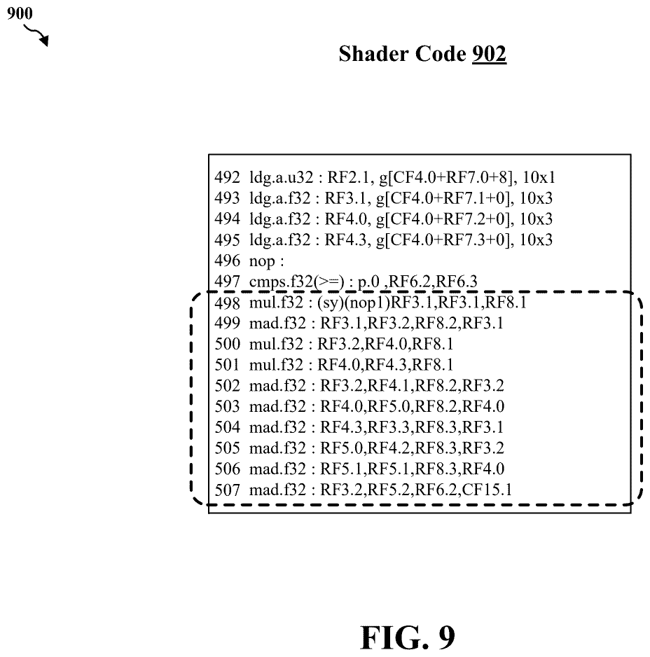

FIG. 9 illustrates diagram 900 including example shader code. More specifically, diagram 900 depicts one example of shader code that is processed at a GPU. As shown in FIG. 9, diagram 900 includes shader code 902 including a number of instructions (e.g., instruction PC 492 through instruction PC 507). FIG. 9 depicts that instructions PC 492-497 correspond to a sample block for an execution unit and/or execution slot. Also, instructions PC 498-507 correspond to another sample block for another execution unit and/or execution slot. That is, instructions PC 492-497 and instructions PC 498-507 may correspond to different sample blocks for different execution units and/or execution slots.

FIG. 9 depicts an example of a shader code sequence for an SP of a GPU. As shown in FIG. 9, the “ldg” instruction may refer to a load global memory instruction. In some aspects, as shown in FIG. 9, assuming a first wave (wave A) and a second wave (wave B) exist as a paired wave in execution slot, an SP or SP scheduler may issue back-to-back global memory load insertion of instruction PC 492, PC 493, PC 494, and PC 495 for wave A. As shown in FIG. 9, the SP or SP scheduler may repeat this process for wave B (i.e., global memory load instruction PC 492, PC 493, PC 494, and PC 495) for wave B. Next, the SP or SP scheduler may then surrender the execution slot for wave A and wave B. Additionally, without any optimizations, the SP or SP scheduler may wait for all memory data of wave A and wave B to return from global memory to the general purpose register (GPR). After this, the SP or SP scheduler may acquire another execution slot, and then initiate the execution starting from instruction PC 498. This execution may be performed from instruction PC 498 through instruction PC 507. As shown in FIG. 9, instruction “RF3.1” of PC 498 may be dependent on the issued “ldg” instructions.

As illustrated in FIG. 9, the SP or SP scheduler may start from instruction PC 498. So this instruction may correspond to resuming an execution of the second wave (wave B) in a wave pair. That is, this instruction may be a resume PC instruction for the wave pair. So when the first wave (wave A) stops executing (e.g., at PC 502), then the SP or SP scheduler may switch back to executing the second wave (wave B). So the process may resume executing the PC instruction at 502 for the first wave, as the first wave stopped. And the SP may then go back to the second wave starting from PC 498. For example, if the first wave issues a resume PC instruction, as the first wave is ready and the second wave is not ready, then second wave resumes at PC 498. However, if the SP issues a stop of the first wave, then the first wave, and the instruction becomes a resume PC instruction.

In some aspects, the SP or SP scheduler may also identify which wave is active and which wave is not active. So the SP or SP scheduler may track the data for each wave until they can rejoin as a wave pair. In order to keep track of the stopping and resuming of the execution of each wave in the wave pair, the SP or SP scheduler may add multiple bits in a context register. That is, adding bits in the context register may help to keep track of when the execution of each wave in the wave pair is stopped and/or resumed. Indeed, the SP or SP scheduler may utilize a number of bits in order to track the progress of the execution of different waves in a wave pair. When the execution of a first wave in a wave pair (wave A) is stopped, the SP may track this by setting a bit in a context register. For example, a bit may be set to ‘1’ or ‘0’ when the execution of one wave is stopped. Also, when the execution of a second wave in a wave pair (wave B) is resumed, the SP may track this by setting another bit in a context register. For example, a bit may be set to ‘0’ or ‘1’ when the execution of one wave is resumed. By doing so, aspects presented herein may track and/or rejoin as the wave pair continues executing. So aspects presented herein may allow for a benefit of starting and stopping a wave pair execution. As there may be a big gap between the first wave data returning and the second wave data returning, it makes sense the SP to track the status of each wave in a wave pair. By doing so, aspects presented herein may allow GPUs to optimize the utilization of execution slots and/or execution units that are idle due to waves not being executed.

In some instances, aspects presented herein may utilize an SP or SP scheduler to waves to an execution slot, maximize the utilization of the execution slot, and/or eliminate the need to perform optimal wave pairing. For instance, an SP or SP scheduler may add one or multiple bits (e.g., 16 bits) in a context register (e.g., a “resume_pc” instruction), a wave mask (e.g., a two bit “active_wave_mask”), and/or a certain mode (e.g., a one bit “solo_mode”) per execution slot. In the example shown in FIG. 9, at instruction PC 498 (e.g., active_wave_mask=2′b11, solo_mode=0), the wave pair may surrender an execution slot. Next, the wave pair may switch out and be added to a wave queue, thus waiting for global memory data to return. In one example, when one wave in the wave pair is ready (e.g., data returned and/or slrc/lrc=0) and another wave is still pending (e.g., waiting for a wave at the wave inception to form a wave pair and/or data for a second wave (wave B) has not returned), the SP or scheduler may switch in the wave pair to an execution slot (compared to a single ready wave). In one example, even if there is just one wave (wave A) that is ready to execute, as shown in FIG. 9, the SP may perform a number of instructions (e.g., set PC 498 as “resume_pc,” set an “active_wave_mask” flag=2′b01, start issuing instruction PC 498, then issue a next instruction for wave A).

In some aspects, if an execution slot with one wave is not active (aka “wave_pair_pending”), this execution slot may be deemed to have low priority compared to other execution slots. That is, the execution slot may issue instructions and be switched out if there are other waiting wave pairs that are ready. Also, once an execution slot starts to execute one wave from a wave pair, the SP may set a certain bit (e.g., a “solo_mode” to 1), as a first wave may stop at some synchronization (e.g., bar, avge, uvge, etc.) or branching instructions. When the second wave is ready, the SP may stop the first wave execution, jump back to resuming the second wave (e.g., resume_pc for the second wave) and set some instructions to-be executed PC (e.g., current_pc), as well as set the first wave as resume PC (e.g., resume_pc). The SP may also update a mask (e.g., “active_wave_mask” to 2′b10) and start executing a second wave instruction. When a current PC instruction is equal to a resume PC instruction (e.g., current_pc=resume_pc), the SP may join the first wave and the second wave together as a wave pair. The SP may also set a mask (e.g., set active_wave_mask=2′b11), a solo mode (e.g., reset solo_mode=0), and the execution slot may go back to a paired wave mode. When a certain mode is enabled (e.g., texture or memory load instructions block issue mode is enabled), the SP or scheduler may split a first wave and a second wave in a wave pair. For example, the SP may issue which instruction should start and end at a certain point (e.g., start with instruction avgs (allocation of vGPR start) and end with avge (allocation of vGPR end)).

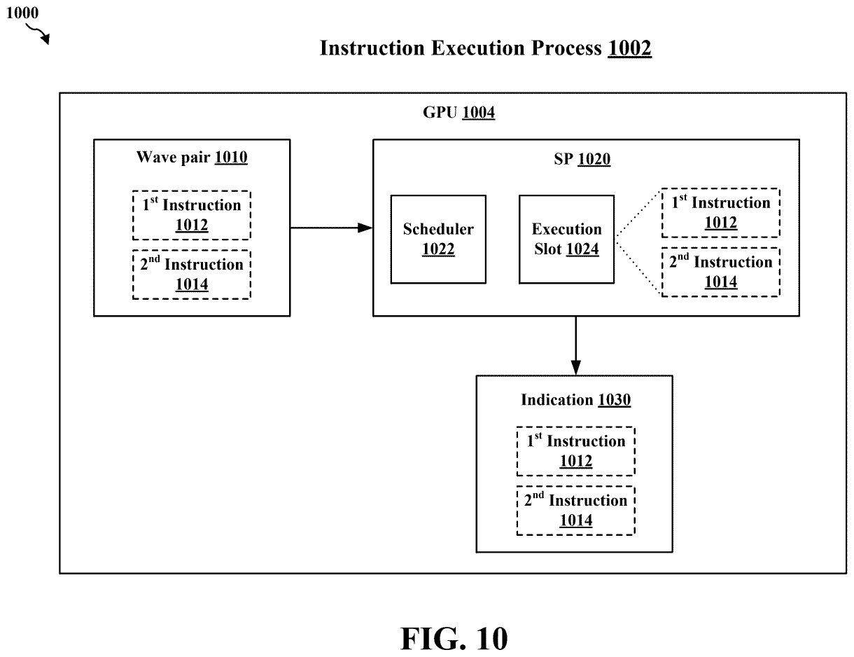

FIG. 10 illustrates diagram 1000 including an example instruction execution process. More specifically, diagram 1000 depicts one example of an instruction execution process 1002 within a GPU 1004. As shown in FIG. 10, diagram 1000 includes GPU 1004, wave pair 1010 including first instruction 1012 and second instruction 1014, SP 1020 including scheduler 1022, execution slot 1024, and indication 1030. As shown in FIG. 10, SP 1020 may assign a first wave (including a first instruction 1012) in a wave pair to an execution unit in execution slot 1024. SP 1020 may assign a second wave (including a second instruction 1014) in the wave pair to an execution unit in execution slot 1024. The execution unit for the first instruction 1012 may be the same as, or different from, the execution unit for the second instruction 1014. The SP 1020 may then initiate the execution of the first wave (including the first instruction 1012) and the second wave (including the second instruction 1014). Next, the SP 1020 may determine whether data is pending for one of the first wave or the second wave. If data is pending for one of the first wave or the second wave, the SP 1020 may identify the first wave and the second wave as a low priority wave pair. The low priority wave pair may include a lower priority compared to a normal priority wave pair in a wave pair hierarchy. Also, the low priority wave pair for the first wave and the second wave may correspond to a partially ready wave pair. That is, if data is pending for the first wave or the second wave, then the first wave and the second wave may be classified as a low priority wave pair or a partially ready wave pair, which may be a low priority wave pair within a wave pair hierarchy.

Additionally, the SP 1020 may set one or more bits in a context register if the first wave and the second wave are classified as a low priority wave pair. That is, the SP 1020 may set one or more bits in a context register if data is pending for the first wave or the second wave. Further, the SP 1020 may change the assigned execution unit for the first wave and the second wave once a low priority wave classification has been determined. Indeed, the SP 1020 may remove an assignment of the first wave and the second wave from an execution unit if the first wave and the second wave are classified as a low priority wave pair. Also, the SP 1020 may add the first wave and the second wave to a wave queue if the first wave and the second wave are classified as a low priority wave pair. Once added to the wave queue, the first wave and the second wave may be executed at a later time or after higher priority waves.

Moreover, the SP 1020 may suspend (i.e., pause or stop) the execution of the first wave and the second wave if the first wave and the second wave are classified as a low priority wave pair. That is, the SP 1020 may suspend (i.e., pause or stop) the execution of the first wave and the second wave if data is pending for the first wave or the second wave. This suspension of the execution of the first wave and the second wave may be based on a synchronization point or a branching instruction. Further, one wave in a wave pair may be suspended while the other wave in the wave pair may be started. For instance, the execution of the first wave may be suspended, but the execution of the second wave may be started if the second wave is ready for execution. Also, in some instances, once the execution of the first wave and/or the second wave has been suspended, the SP 1020 may monitor for whether data is still pending for one of the first instruction or the second instruction (e.g., the first instruction and the second instruction may be from different waves in a wave pair). The SP 1020 may determine that data is not pending for the first wave or the second wave. Also, SP 1020 may identify the first wave and the second wave as a normal priority wave pair based on the data not being pending for the first wave or the second wave. That is, SP 1020 may increase a wave priority in a wave pair hierarchy for the first wave or the second wave. The SP 1020 may also complete the execution of the first wave or the second wave based on the wave pair being a normal priority wave pair. This execution of the first wave and the second wave may be completed in a paired wave mode. Moreover, the SP 1020 may complete the execution of the first wave and the second wave based on the execution unit not being idle for the first wave and the second wave. Also, the SP 1020 may output an indication 1030 of a suspension of the execution of the first instruction and the second instruction.

Aspects of the present disclosure may include a number of benefits or advantages. Aspects of the present disclosure may help to reduce the overhead at a GPU that is needed during wave execution. For instance, aspects presented herein may reduce the amount of overhead at a GPU that is needed for paired wave execution. Aspects presented herein may also reduce the amount of time needed at a GPU to execute waves. For example, aspects of the present disclosure may reduce the amount of time needed at a GPU to execute the paired wave. That is, aspects presented herein may allow a GPU to increase the speed and/or performance during paired wave execution. Also, aspects presented herein may increase the efficiency of resources utilization for wave execution. Indeed, aspects presented herein may more efficiently utilize execution slots and/or execution units during paired wave execution. By doing so, aspects presented herein may optimize the performance of a GPU during paired wave execution. Aspects herein may also eliminate the complexity to select a wave or wave pair to an execution slot, increase execution slot utilization, and/or improve instruction cache fetch utilization. Aspects herein may also reduce overhead for wave pair synchronization, as well as contribute to performance uplift at a GPU.

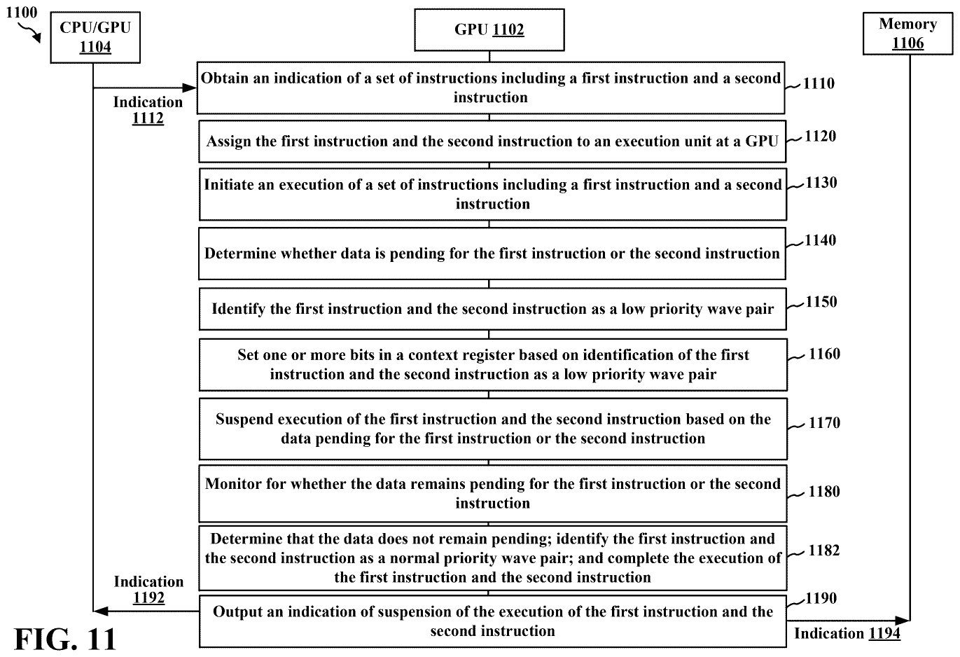

FIG. 11 is a communication flow diagram 1100 of graphics processing in accordance with one or more techniques of this disclosure. As shown in FIG. 11, diagram 1100 includes example communications between GPU 1102 (e.g., a GPU, a graphics pipeline at a GPU, a shader processor at a GPU, a streaming processor at a GPU, a GPU component, another graphics processor, a CPU, a CPU component, or another central processor), CPU/GPU 1104 (e.g., a CPU, a CPU component, or another central processor, a GPU, a graphics pipeline at a GPU, a shader processor at a GPU, a GPU component, or another graphics processor), and memory 1106 (e.g., a memory, a cache, a system memory, a graphics memory, a memory or cache at a CPU, or a memory or cache at a GPU), in accordance with one or more techniques of this disclosure.

At 1110, GPU 1102 may obtain an indication of a set of instructions including a first instruction and a second instruction, where the set of instructions is associated with graphics processing. For example, GPU 1102 may obtain indication 1112 from CPU/GPU 1104. In some aspects, the first instruction may be associated with a first wave and the second instruction may be associated with a second wave at a graphics processing unit (GPU), where the first wave and the second wave correspond to a wave pair. Also, the set of instructions may be a set of shader instructions associated with a shader code for the graphics processing, where the first instruction is a first texture load instruction or a first memory load instruction, and where the second instruction is a second texture load instruction or a second memory load instruction.

At 1120, GPU 1102 may assign the first instruction and the second instruction to an execution unit in a set of execution units at a graphics processing unit (GPU).

At 1130, GPU 1102 may initiate an execution of a set of instructions including a first instruction and a second instruction. In some aspects, initiating the execution of the first instruction and the second instruction may comprise initiating the execution of the first instruction and the second instruction at an execution unit.

At 1140, GPU 1102 may determine whether data is pending for one of the first instruction or the second instruction (e.g., the first instruction and the second instruction may be from different waves in a wave pair).

At 1150, GPU 1102 may identify the first instruction and the second instruction as a low priority wave pair based on the data being pending for one of the first instruction or the second instruction (e.g., the first instruction and the second instruction may be from different waves in a wave pair). Also, the low priority wave pair may include a lower priority compared to a normal priority wave pair in a wave pair hierarchy. In some aspects, identifying the first instruction and the second instruction as the low priority wave pair may comprise reducing a priority of the first instruction and the second instruction in the wave pair hierarchy. Further, the low priority wave pair for the first instruction and the second instruction may correspond to a partially ready wave pair.

At 1160, GPU 1102 may set one or more bits in a context register based on identification of the first instruction and the second instruction as the low priority wave pair. Also, at 1160, GPU 1102 may remove an assignment of the first instruction and the second instruction from the execution unit based on the identification of the first instruction and the second instruction as the low priority wave pair. Further, at 1160, GPU 1102 may add the first instruction and the second instruction to a wave queue based on the removal of the assignment of the first instruction and the second instruction from the execution unit. In some aspects, setting the one or more bits in the context register may comprise setting the one or more bits in the context register at a streaming processor (SP) in a graphics processing unit (GPU) or a scheduler of the SP.

At 1170, GPU 1102 may suspend the execution of the first instruction and the second instruction based on the data being pending for one of the first instruction or the second instruction (e.g., the first instruction and the second instruction may be from different waves in a wave pair). In some aspects, suspending the execution of the first instruction and the second instruction may comprise: stopping the execution of the first instruction and the second instruction further based on a synchronization point or a branching instruction for the first instruction and the second instruction. Additionally, suspending the execution of the first instruction and the second instruction may comprise: stopping the execution of the first instruction and starting the execution of the second instruction based on the second instruction being ready for the execution.

At 1180, GPU 1102 may monitor for whether the data remains pending for one of the first instruction or the second instruction (e.g., the first instruction and the second instruction may be from different waves in a wave pair).

At 1182, GPU 1102 may determine that the data does not remain pending for one of the first instruction or the second instruction (e.g., the first instruction and the second instruction may be from different waves in a wave pair). Also, at 1182, GPU 1102 may identify the first instruction and the second instruction as a normal priority wave pair based on the data not being pending for one of the first instruction or the second instruction. In some aspects, identifying the first instruction and the second instruction as the normal priority wave pair may comprise increasing a wave priority in a wave pair hierarchy for the first instruction and the second instruction, where the normal priority wave pair may include a higher priority compared to a low priority wave pair in the wave pair hierarchy. Further, at 1182, GPU 1102 may complete the execution of the first instruction and the second instruction based on identification of the first instruction and the second instruction as the normal priority wave pair. In some aspects, completing the execution of the first instruction and the second instruction may comprise completing the execution of the first instruction and the second instruction in a paired wave mode. Moreover, at 1182, GPU 1102 may complete the execution of the first instruction and the second instruction based on the execution unit not being idle for one of the first instruction or the second instruction (e.g., the first instruction and the second instruction may be from different waves in a wave pair).

At 1190, GPU 1102 may output an indication of suspension of the execution of the first instruction and the second instruction. In some aspects, outputting the indication of the suspension of the execution of the first instruction and the second instruction may comprise transmitting the indication of the suspension of the execution of the first instruction and the second instruction. For example, GPU 1102 may transmit indication 1192 to CPU/GPU 1104. Also, outputting the indication of the suspension of the execution of the first instruction and the second instruction may comprise storing the indication of the suspension of the execution of the first instruction and the second instruction. For example, GPU 1102 may store indication 1194 in memory 1106.

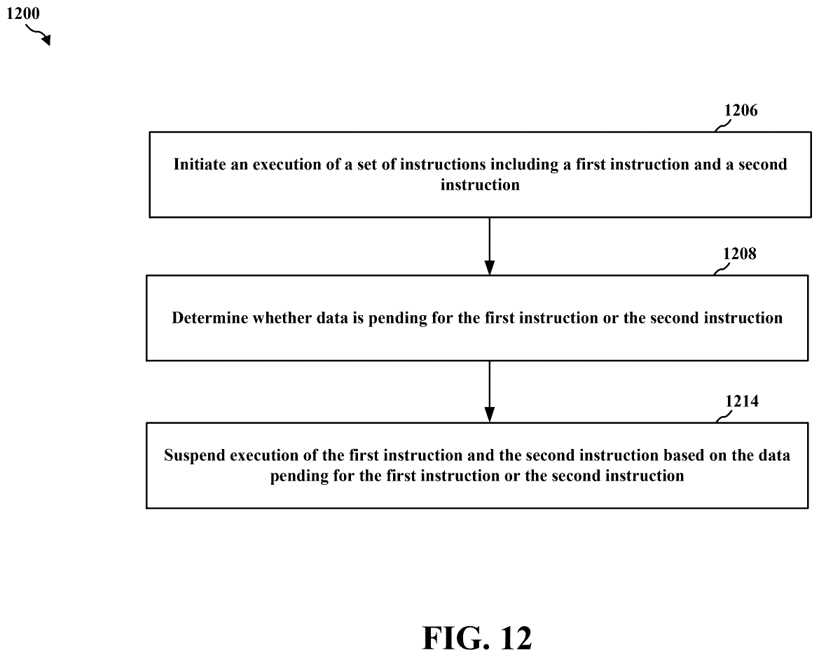

FIG. 12 is a flowchart 1200 of an example method of graphics processing in accordance with one or more techniques of this disclosure. The method may be performed by a GPU (e.g., a GPU, a graphics pipeline at a GPU, a shader processor at a GPU, a streaming processor at a GPU, a GPU component, another graphics processor, a CPU, a CPU component, or another central processor), a CPU/GPU (e.g., a CPU, a CPU component, another central processor, a GPU, a shader processor at a GPU, a streaming processor at a GPU, a GPU component, or another graphics processor), a display driver integrated circuit (DDIC), an apparatus for graphics processing, a wireless communication device, and/or any apparatus that may perform graphics processing as used in connection with the examples of FIGS. 1-11.

At 1206, the GPU may initiate an execution of a set of instructions including a first instruction and a second instruction, as described in connection with the examples in FIGS. 1-11. For example, as described in 1130 of FIG. 11, GPU 1102 may initiate an execution of a set of instructions including a first instruction and a second instruction Further, step 1206 may be performed by processing unit 120 in FIG. 1. In some aspects, initiating the execution of the first instruction and the second instruction may comprise initiating the execution of the first instruction and the second instruction at an execution unit.

At 1208, the GPU may determine whether data is pending for one of the first instruction or the second instruction, as described in connection with the examples in FIGS. 1-11. For example, as described in 1140 of FIG. 11, GPU 1102 may determine whether data is pending for one of the first instruction or the second instruction. Further, step 1208 may be performed by processing unit 120 in FIG. 1.

At 1214, the GPU may suspend the execution of the first instruction and the second instruction based on the data being pending for one of the first instruction or the second instruction, as described in connection with the examples in FIGS. 1-11. For example, as described in 1170 of FIG. 11, GPU 1102 may suspend the execution of the first instruction and the second instruction based on the data being pending for one of the first instruction or the second instruction. Further, step 1214 may be performed by processing unit 120 in FIG. 1. In some aspects, suspending the execution of the first instruction and the second instruction may comprise: stopping the execution of the first instruction and the second instruction further based on a synchronization point or a branching instruction for the first instruction and the second instruction. Additionally, suspending the execution of the first instruction and the second instruction may comprise: stopping the execution of the first instruction and starting the execution of the second instruction based on the second instruction being ready for the execution.

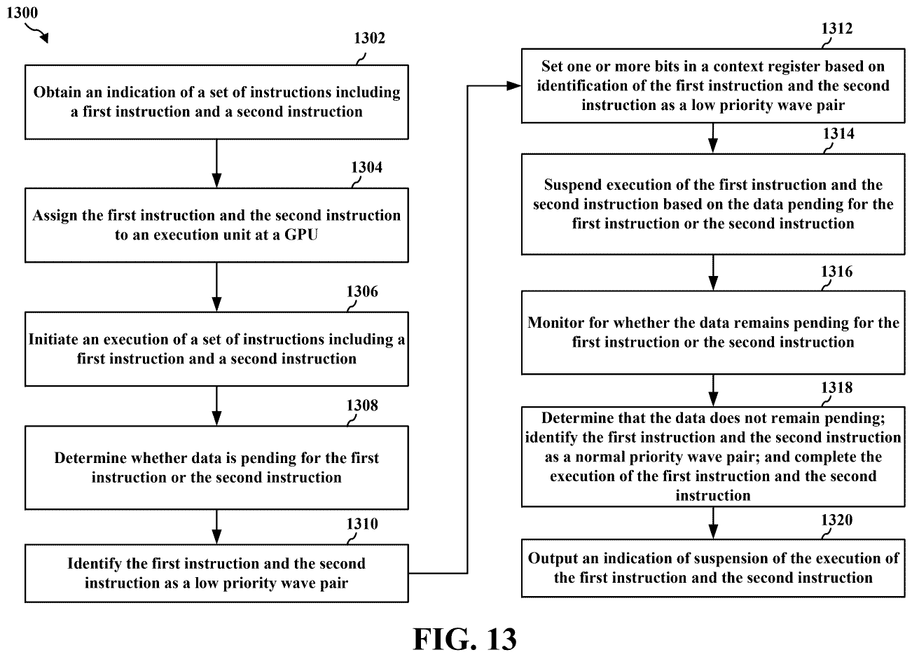

FIG. 13 is a flowchart 1300 of an example method of graphics processing in accordance with one or more techniques of this disclosure. The method may be performed by a GPU (e.g., a GPU, a graphics pipeline at a GPU, a shader processor at a GPU, a streaming processor at a GPU, a GPU component, another graphics processor, a CPU, a CPU component, or another central processor), a CPU/GPU (e.g., a CPU, a CPU component, another central processor, a GPU, a shader processor at a GPU, a streaming processor at a GPU, a GPU component, or another graphics processor), a display driver integrated circuit (DDIC), an apparatus for graphics processing, a wireless communication device, and/or any apparatus that may perform graphics processing as used in connection with the examples of FIGS. 1-11.

At 1302, the GPU may obtain an indication of a set of instructions including a first instruction and a second instruction, where the set of instructions is associated with graphics processing, as described in connection with the examples in FIGS. 1-11. For example, as described in 1110 of FIG. 11, GPU 1102 may obtain an indication of a set of instructions including a first instruction and a second instruction, where the set of instructions is associated with graphics processing. Further, step 1302 may be performed by processing unit 120 in FIG. 1. In some aspects, the first instruction may be associated with a first wave and the second instruction may be associated with a second wave at a graphics processing unit (GPU), where the first wave and the second wave correspond to a wave pair. Also, the set of instructions may be a set of shader instructions associated with a shader code for the graphics processing, where the first instruction is a first texture load instruction or a first memory load instruction, and where the second instruction is a second texture load instruction or a second memory load instruction.

At 1304, the GPU may assign the first instruction and the second instruction to an execution unit in a set of execution units at a graphics processing unit (GPU), as described in connection with the examples in FIGS. 1-11. For example, as described in 1120 of FIG. 11, GPU 1102 may assign the first instruction and the second instruction to an execution unit in a set of execution units at a graphics processing unit (GPU). Further, step 1304 may be performed by processing unit 120 in FIG. 1.

At 1306, the GPU may initiate an execution of a set of instructions including a first instruction and a second instruction, as described in connection with the examples in FIGS. 1-11. For example, as described in 1130 of FIG. 11, GPU 1102 may initiate an execution of a set of instructions including a first instruction and a second instruction Further, step 1306 may be performed by processing unit 120 in FIG. 1. In some aspects, initiating the execution of the first instruction and the second instruction may comprise initiating the execution of the first instruction and the second instruction at an execution unit.

At 1308, the GPU may determine whether data is pending for one of the first instruction or the second instruction, as described in connection with the examples in FIGS. 1-11. For example, as described in 1140 of FIG. 11, GPU 1102 may determine whether data is pending for one of the first instruction or the second instruction. Further, step 1308 may be performed by processing unit 120 in FIG. 1.

At 1310, the GPU may identify the first instruction and the second instruction as a low priority wave pair based on the data being pending for one of the first instruction or the second instruction, as described in connection with the examples in FIGS. 1-11. For example, as described in 1150 of FIG. 11, GPU 1102 may identify the first instruction and the second instruction as a low priority wave pair based on the data being pending for one of the first instruction or the second instruction. Further, step 1310 may be performed by processing unit 120 in FIG. 1. Also, the low priority wave pair may include a lower priority compared to a normal priority wave pair in a wave pair hierarchy. In some aspects, identifying the first instruction and the second instruction as the low priority wave pair may comprise reducing a priority of the first instruction and the second instruction in the wave pair hierarchy. Further, the low priority wave pair for the first instruction and the second instruction may correspond to a partially ready wave pair.

At 1312, the GPU may set one or more bits in a context register based on identification of the first instruction and the second instruction as the low priority wave pair, as described in connection with the examples in FIGS. 1-11. For example, as described in 1160 of FIG. 11, GPU 1102 may set one or more bits in a context register based on identification of the first instruction and the second instruction as the low priority wave pair. Further, step 1312 may be performed by processing unit 120 in FIG. 1. Also, at 1312, GPU may remove an assignment of the first instruction and the second instruction from the execution unit based on the identification of the first instruction and the second instruction as the low priority wave pair. Further, at 1312, GPU may add the first instruction and the second instruction to a wave queue based on the removal of the assignment of the first instruction and the second instruction from the execution unit. In some aspects, setting the one or more bits in the context register may comprise setting the one or more bits in the context register at a streaming processor (SP) in a graphics processing unit (GPU) or a scheduler of the SP.

At 1314, the GPU may suspend the execution of the first instruction and the second instruction based on the data being pending for one of the first instruction or the second instruction, as described in connection with the examples in FIGS. 1-11. For example, as described in 1170 of FIG. 11, GPU 1102 may suspend the execution of the first instruction and the second instruction based on the data being pending for one of the first instruction or the second instruction. Further, step 1314 may be performed by processing unit 120 in FIG. 1. In some aspects, suspending the execution of the first instruction and the second instruction may comprise: stopping the execution of the first instruction and the second instruction further based on a synchronization point or a branching instruction for the first instruction and the second instruction. Additionally, suspending the execution of the first instruction and the second instruction may comprise: stopping the execution of the first instruction and starting the execution of the second instruction based on the second instruction being ready for the execution.

At 1316, the GPU may monitor for whether the data remains pending for one of the first instruction or the second instruction, as described in connection with the examples in FIGS. 1-11. For example, as described in 1180 of FIG. 11, GPU 1102 may monitor for whether the data remains pending for one of the first instruction or the second instruction. Further, step 1316 may be performed by processing unit 120 in FIG. 1.

At 1318, the GPU may determine that the data does not remain pending for one of the first instruction or the second instruction, as described in connection with the examples in FIGS. 1-11. For example, as described in 1182 of FIG. 11, GPU 1102 may determine that the data does not remain pending for one of the first instruction or the second instruction. Further, step 1318 may be performed by processing unit 120 in FIG. 1. Also, at 1318, the GPU may identify the first instruction and the second instruction as a normal priority wave pair based on the data not being pending for one of the first instruction or the second instruction. For example, as described in 1182 of FIG. 11, GPU 1102 may identify the first instruction and the second instruction as a normal priority wave pair based on the data not being pending for one of the first instruction or the second instruction. In some aspects, identifying the first instruction and the second instruction as the normal priority wave pair may comprise increasing a wave priority in a wave pair hierarchy for the first instruction and the second instruction, where the normal priority wave pair may include a higher priority compared to a low priority wave pair in the wave pair hierarchy. Further, at 1318, the GPU may complete the execution of the first instruction and the second instruction based on identification of the first instruction and the second instruction as the normal priority wave pair. For example, as described in 1182 of FIG. 11, GPU 1102 may complete the execution of the first instruction and the second instruction based on identification of the first instruction and the second instruction as the normal priority wave pair. In some aspects, completing the execution of the first instruction and the second instruction may comprise completing the execution of the first instruction and the second instruction in a paired wave mode. Moreover, at 1318, the GPU may complete the execution of the first instruction and the second instruction based on the execution unit not being idle for one of the first instruction or the second instruction. For example, as described in 1182 of FIG. 11, GPU 1102 may complete the execution of the first instruction and the second instruction based on the execution unit not being idle for one of the first instruction or the second instruction.

At 1320, the GPU may output an indication of suspension of the execution of the first instruction and the second instruction, as described in connection with the examples in FIGS. 1-11. For example, as described in 1190 of FIG. 11, GPU 1102 may output an indication of suspension of the execution of the first instruction and the second instruction. Further, step 1320 may be performed by processing unit 120 in FIG. 1. In some aspects, outputting the indication of the suspension of the execution of the first instruction and the second instruction may comprise transmitting the indication of the suspension of the execution of the first instruction and the second instruction. For example, GPU 1102 may transmit indication 1192 to CPU/GPU 1104. Also, outputting the indication of the suspension of the execution of the first instruction and the second instruction may comprise storing the indication of the suspension of the execution of the first instruction and the second instruction. For example, GPU 1102 may store indication 1194 in memory 1106.

In configurations, a method or an apparatus for graphics processing is provided. The apparatus may be a GPU (or other graphics processor), a CPU (or other central processor), a DDIC, an apparatus for graphics processing, and/or some other processor that may perform graphics processing. In aspects, the apparatus may be the processing unit 120 within the device 104, or may be some other hardware within the device 104 or another device. The apparatus, e.g., processing unit 120, may include means for initiating an execution of a set of instructions including a first instruction and a second instruction. The apparatus, e.g., processing unit 120, may also include means for determining whether data is pending for one of the first instruction or the second instruction. The apparatus, e.g., processing unit 120, may also include means for suspending the execution of the first instruction and the second instruction based on the data being pending for one of the first instruction or the second instruction. The apparatus, e.g., processing unit 120, may also include means for identifying the first instruction and the second instruction as a low priority wave pair based on the data being pending for one of the first instruction or the second instruction. The apparatus, e.g., processing unit 120, may also include means for setting one or more bits in a context register based on identification of the first instruction and the second instruction as the low priority wave pair. The apparatus, e.g., processing unit 120, may also include means for removing an assignment of the first instruction and the second instruction from the execution unit based on the identification of the first instruction and the second instruction as the low priority wave pair. The apparatus, e.g., processing unit 120, may also include means for adding the first instruction and the second instruction to a wave queue based on the removal of the assignment of the first instruction and the second instruction from the execution unit. The apparatus, e.g., processing unit 120, may also include means for monitoring for whether the data remains pending for one of the first instruction or the second instruction. The apparatus, e.g., processing unit 120, may also include means for determining that the data does not remain pending for one of the first instruction or the second instruction. The apparatus, e.g., processing unit 120, may also include means for identifying the first instruction and the second instruction as a normal priority wave pair based on the data not being pending for one of the first instruction or the second instruction. The apparatus, e.g., processing unit 120, may also include means for completing the execution of the first instruction and the second instruction based on identification of the first instruction and the second instruction as the normal priority wave pair. The apparatus, e.g., processing unit 120, may also include means for completing the execution of the first instruction and the second instruction based on the execution unit not being idle for one of the first instruction or the second instruction. The apparatus, e.g., processing unit 120, may also include means for obtaining an indication of the set of instructions including the first instruction and the second instruction, where the set of instructions is associated with the graphics processing. The apparatus, e.g., processing unit 120, may also include means for assigning the first instruction and the second instruction to the execution unit in a set of execution units at a graphics processing unit (GPU). The apparatus, e.g., processing unit 120, may also include means for outputting an indication of suspension of the execution of the first instruction and the second instruction.

The subject matter described herein may be implemented to realize one or more benefits or advantages. For instance, the described graphics processing techniques may be used by a GPU, a shader processor, a streaming processor, a CPU, a central processor, or some other processor that may perform graphics processing to implement the wave execution techniques described herein. This may also be accomplished at a low cost compared to other graphics processing techniques. Moreover, the graphics processing techniques herein may improve or speed up data processing or execution. Further, the graphics processing techniques herein may improve resource or data utilization and/or resource efficiency. Additionally, aspects of the present disclosure may utilize wave execution techniques in order to improve memory bandwidth efficiency and/or increase processing speed at a GPU, a shader processor, a CPU, or a display processing unit (DPU).

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer-readable media may comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is an apparatus for graphics processing, including at least one memory; and at least one processor coupled to the at least one memory and, based at least in part on information stored in the at least one memory, the at least one processor, individually or in any combination, is configured to: initiate an execution of a set of instructions including a first instruction and a second instruction; determine whether data is pending for one of the first instruction or the second instruction; and suspend the execution of the first instruction and the second instruction based on the data being pending for one of the first instruction or the second instruction.

Aspect 2 is the apparatus of aspect 1, wherein the at least one processor, individually or in any combination, is further configured to: identify the first instruction and the second instruction as a low priority wave pair based on the data being pending for one of the first instruction or the second instruction.

Aspect 3 is the apparatus of aspect 2, wherein the at least one processor, individually or in any combination, is further configured to: set one or more bits in a context register based on identification of the first instruction and the second instruction as the low priority wave pair.

Aspect 4 is the apparatus of aspect 3, wherein the at least one processor, individually or in any combination, is further configured to: remove an assignment of the first instruction and the second instruction from the execution unit based on the identification of the first instruction and the second instruction as the low priority wave pair; and add the first instruction and the second instruction to a wave queue based on the removal of the assignment of the first instruction and the second instruction from the execution unit.

Aspect 5 is the apparatus of any of aspects 3 to 4, wherein to set the one or more bits in the context register, the at least one processor, individually or in any combination, is configured to: set the one or more bits in the context register at a streaming processor (SP) in a graphics processing unit (GPU) or a scheduler of the SP.

Aspect 6 is the apparatus of any of aspects 2 to 5, wherein the low priority wave pair includes a lower priority compared to a normal priority wave pair in a wave pair hierarchy.

Aspect 7 is the apparatus of aspect 6, wherein to identify the first instruction and the second instruction as the low priority wave pair, the at least one processor, individually or in any combination, is configured to: reduce a priority of the first instruction and the second instruction in the wave pair hierarchy.

Aspect 8 is the apparatus of any of aspects 6 to 7, wherein the low priority wave pair for the first instruction and the second instruction corresponds to a partially ready wave pair.

Aspect 9 is the apparatus of any of aspects 1 to 8, wherein the at least one processor, individually or in any combination, is further configured to: monitor for whether the data remains pending for one of the first instruction or the second instruction.

Aspect 10 is the apparatus of aspect 9, wherein the at least one processor, individually or in any combination, is further configured to: determine that the data does not remain pending for one of the first instruction or the second instruction; and identify the first instruction and the second instruction as a normal priority wave pair based on the data not being pending for one of the first instruction or the second instruction.

Aspect 11 is the apparatus of aspect 10, wherein to identify the first instruction and the second instruction as the normal priority wave pair, the at least one processor, individually or in any combination, is configured to: increase a wave priority in a wave pair hierarchy for the first instruction and the second instruction, wherein the normal priority wave pair includes a higher priority compared to a low priority wave pair in the wave pair hierarchy.

Aspect 12 is the apparatus of any of aspects 10 to 11, wherein the at least one processor, individually or in any combination, is further configured to: complete the execution of the first instruction and the second instruction based on identification of the first instruction and the second instruction as the normal priority wave pair.

Aspect 13 is the apparatus of aspect 12, wherein to complete the execution of the first instruction and the second instruction, the at least one processor, individually or in any combination, is configured to: complete the execution of the first instruction and the second instruction in a paired wave mode.

Aspect 14 is the apparatus of any of aspects 9 to 13, wherein the at least one processor, individually or in any combination, is further configured to: complete the execution of the first instruction and the second instruction based on the execution unit not being idle for one of the first instruction or the second instruction.

Aspect 15 is the apparatus of any of aspects 1 to 14, wherein to suspend the execution of the first instruction and the second instruction, the at least one processor, individually or in any combination, is configured to: stop the execution of the first instruction and the second instruction further based on a synchronization point or a branching instruction for the first instruction and the second instruction.

Aspect 16 is the apparatus of any of aspects 1 to 15, wherein to suspend the execution of the first instruction and the second instruction, the at least one processor, individually or in any combination, is configured to: stop the execution of the first instruction and starting the execution of the second instruction based on the second instruction being ready for the execution.

Aspect 17 is the apparatus of any of aspects 1 to 16, wherein the at least one processor, individually or in any combination, is further configured to: obtain an indication of the set of instructions including the first instruction and the second instruction, wherein the set of instructions is associated with the graphics processing.

Aspect 18 is the apparatus of aspect 17, wherein the at least one processor, individually or in any combination, is further configured to: assign the first instruction and the second instruction to the execution unit in a set of execution units at a graphics processing unit (GPU), and wherein to initiate the execution of the first instruction and the second instruction, the at least one processor, individually or in any combination, is configured to: initiate the execution of the first instruction and the second instruction at the execution unit.

Aspect 19 is the apparatus of any of aspects 1 to 18, wherein the first instruction is associated with a first wave and the second instruction is associated with a second wave at a graphics processing unit (GPU), wherein the first wave and the second wave correspond to a wave pair.

Aspect 20 is the apparatus of any of aspects 1 to 19, wherein the set of instructions is a set of shader instructions associated with a shader code for the graphics processing, wherein the first instruction is a first texture load instruction or a first memory load instruction, and wherein the second instruction is a second texture load instruction or a second memory load instruction.

Aspect 21 is the apparatus of any of aspects 1 to 18, wherein the at least one processor, individually or in any combination, is further configured to: output an indication of suspension of the execution of the first instruction and the second instruction.

Aspect 22 is the apparatus of aspect 21, wherein to output the indication of the suspension of the execution of the first instruction and the second instruction, the at least one processor, individually or in any combination, is configured to: transmit the indication of the suspension of the execution of the first instruction and the second instruction; or store the indication of the suspension of the execution of the first instruction and the second instruction.

Aspect 23 is the apparatus of aspect 22, wherein the apparatus is a wireless communication device, further including (i.e., comprising) at least one of an antenna or a transceiver coupled to the at least one processor, wherein to transmit the indication of the suspension of the execution of the first instruction and the second instruction, the at least one processor is configured to: transmit, via at least one of the antenna or the transceiver, the indication of the suspension of the execution of the first instruction and the second instruction.

Aspect 24 is a method of graphics processing for implementing any of aspects 1 to 23.

Aspect 25 is an apparatus for graphics processing including means for implementing any of aspects 1 to 23.

Aspect 26 is a computer-readable medium (e.g., a non-transitory computer-readable medium) storing computer executable code (e.g., code for graphics processing), the code when executed by a processor causes the processor to implement any of aspects 1 to 23.

What is claimed is:

1. An apparatus for graphics processing, comprising:
at least one memory; and
at least one processor coupled to the at least one memory and, based at least in part on information stored in the at least one memory, the at least one processor is configured to:
initiate an execution of a set of instructions including a first instruction and a second instruction;
determine whether data is pending for one of the first instruction or the second instruction; and
suspend the execution of the first instruction and the second instruction based on the data being pending for one of the first instruction or the second instruction.

2. The apparatus of claim 1, wherein the at least one processor is further configured to:
identify the first instruction and the second instruction as a low priority wave pair based on the data being pending for one of the first instruction or the second instruction.

3. The apparatus of claim 2, wherein the at least one processor is further configured to:
set one or more bits in a context register based on identification of the first instruction and the second instruction as the low priority wave pair.

4. The apparatus of claim 3, wherein the at least one processor is further configured to:
remove an assignment of the first instruction and the second instruction from an execution unit based on the identification of the first instruction and the second instruction as the low priority wave pair; and
add the first instruction and the second instruction to a wave queue based on the removal of the assignment of the first instruction and the second instruction from the execution unit.

5. The apparatus of claim 3, wherein to set the one or more bits in the context register, the at least one processor is configured to: set the one or more bits in the context register at a streaming processor (SP) in a graphics processing unit (GPU) or a scheduler of the SP.

6. The apparatus of claim 2, wherein the low priority wave pair includes a lower priority compared to a normal priority wave pair in a wave pair hierarchy.

7. The apparatus of claim 6, wherein to identify the first instruction and the second instruction as the low priority wave pair, the at least one processor is configured to: reduce a priority of the first instruction and the second instruction in the wave pair hierarchy, and wherein the low priority wave pair for the first instruction and the second instruction corresponds to a partially ready wave pair.

8. The apparatus of claim 1, wherein the at least one processor is further configured to:
monitor for whether the data remains pending for one of the first instruction or the second instruction.

9. The apparatus of claim 8, wherein the at least one processor is further configured to:
determine that the data does not remain pending for one of the first instruction or the second instruction; and
identify the first instruction and the second instruction as a normal priority wave pair based on the data not being pending for one of the first instruction or the second instruction.

10. The apparatus of claim 9, wherein to identify the first instruction and the second instruction as the normal priority wave pair, the at least one processor is configured to:
increase a wave priority in a wave pair hierarchy for the first instruction and the second instruction, wherein the normal priority wave pair includes a higher priority compared to a low priority wave pair in the wave pair hierarchy.

11. The apparatus of claim 9, wherein the at least one processor is further configured to:
complete the execution of the first instruction and the second instruction based on identification of the first instruction and the second instruction as the normal priority wave pair.

12. The apparatus of claim 11, wherein to complete the execution of the first instruction and the second instruction, the at least one processor is configured to: complete the execution of the first instruction and the second instruction in a paired wave mode.

13. The apparatus of claim 8, wherein the at least one processor is further configured to:
complete the execution of the first instruction and the second instruction based on an execution unit not being idle for one of the first instruction or the second instruction.

14. The apparatus of claim 1, wherein to suspend the execution of the first instruction and the second instruction, the at least one processor is configured to: stop the execution of the first instruction and the second instruction further based on a synchronization point or a branching instruction for the first instruction and the second instruction.

15. The apparatus of claim 1, wherein to suspend the execution of the first instruction and the second instruction, the at least one processor is configured to: stop the execution of the first instruction and starting the execution of the second instruction based on the second instruction being ready for the execution.

16. The apparatus of claim 1, wherein the at least one processor is further configured to:
obtain an indication of the set of instructions including the first instruction and the second instruction, wherein the set of instructions is associated with the graphics processing; and
assign the first instruction and the second instruction to an execution unit in a set of execution units at a graphics processing unit (GPU), and wherein to initiate the execution of the first instruction and the second instruction, the at least one processor is configured to: initiate the execution of the first instruction and the second instruction at the execution unit.

17. The apparatus of claim 1, wherein the first instruction is associated with a first wave and the second instruction is associated with a second wave at a graphics processing unit (GPU), wherein the first wave and the second wave correspond to a wave pair, wherein the set of instructions is a set of shader instructions associated with a shader code for the graphics processing, wherein the first instruction is a first texture load instruction or a first memory load instruction, and wherein the second instruction is a second texture load instruction or a second memory load instruction.

18. The apparatus of claim 1, further comprising:
outputting an indication of suspension of the execution of the first instruction and the second instruction.

19. A method of graphics processing, comprising:
initiating an execution of a set of instructions including a first instruction and a second instruction;
determining whether data is pending for one of the first instruction or the second instruction; and
suspending the execution of the first instruction and the second instruction based on the data being pending for one of the first instruction or the second instruction.

20. A computer-readable medium storing computer executable code for graphics processing, the code when executed by at least one processor causes the at least one processor to:
initiate an execution of a set of instructions including a first instruction and a second instruction;
determine whether data is pending for one of the first instruction or the second instruction; and
suspend the execution of the first instruction and the second instruction based on the data being pending for one of the first instruction or the second instruction.
